(19) United States
(12) Patent Application Publication
(10) Pub. No.: US 2010/0226658 A1
(43) Pub. Date: Sep. 9, 2010

(54) OPTICAL RECEIVING APPARATUS, METHOD FOR OPTICAL RECEPTION, AND OPTICAL TRANSMISSION SYSTEM

(75) Inventors: Takahiro Fujimoto, Kawasaki (JP); Kensuke Matsui, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/704,566

(22) Filed: Feb. 12, 2010

(30) Foreign Application Priority Data
Mar. 5, 2009 (JP) 2009-052345

(51) Int. Cl. H04B 10/12; H04B 10/06

(52) U.S. Cl. 398/141; 398/214

(57) ABSTRACT

An optical receiving apparatus, including an optical interferometer including first and second optical waveguides having light paths different in length and converting a phase modulated signal received by the optical receiving apparatus into an intensity modulated signal, monitors the results of the detecting by the temperature detector and the measuring by the electric current measure while sweeping the temperature of the first optical waveguide in a predetermined range; selects the temperature of the first optical waveguide at which temperature the average photocurrent has an extreme value based on the result of the monitoring; and varies the temperature of the first optical waveguide to the selected temperature.

### CROSS-REFERENCE TO RELATED APPLICATION

This application is based upon and claims the benefit of priority of the prior Japanese Application No. 2009-052345 filed on Mar. 5, 2009 in Japan, the entire contents of which are hereby incorporated by reference.

### FIELD

The embodiments discussed herein are related to an optical receiving apparatus, a method for optical reception, and an optical transmission system. The optical transmission system includes, for example, one which transmits a light signal having been phase-modulated.

### BACKGROUND

In order to realize a high-capacity data transmission, there has recently been examined an optical transmission system using a modulation scheme such as Differential Phase Shift Keying (DPSK).

In the above optical transmission system, a light signal (hereinafter simply called a DPSK light signal) modulated in the DPSK scheme is transmitted through an optical transmission path and received in an optical receiving apparatus. A phase modulated scheme such as DPSK attaches information required for an intensity modulated signal to a phase modulated signal through, for example, precoding processing in the transmitting apparatus pervious to phase modulation processing.

For the above, when receiving a DPSK light signal from an optical transmitting apparatus, an optical receiving apparatus can demodulate the DPSK light signal serving as a phase modulated signal into an intensity modulated signal by, for example, applying a predetermined delay difference to the DPSK light signal for interference.

FIG. 1A denotes an example of a DPSK light signal (input signal) received in the optical receiving signal. A delay interferometer included in the optical receiving apparatus power-divides the input signal into two components, delays one of the components by one symbol (i.e., shifts one component by one symbol) and thereby obtains a delayed signal as denoted in FIG. 1B. Thus, the delay interferometer causes the one component (the delayed signal) and the other component (the input signal) to interfere with each other. If the input signal and the delayed signal at the same time point are in phase, the interference is constructive while, if the input signal and the delayed signal at the same time point are out of phase, the interference is destructive. Therefore, the optical receiving apparatus can obtain an intensity modulated signal (demodulated signal) as denoted in FIG. 1C, for example.

However, since an amount of delay to obtain such a delayed signal varies with the environment of the optical transmission system, the optical receiving apparatus activates the delay interferometer after adjusting the amount of delay for the delay interferometer.

As the technique of reception of a phase modulated signal after converted into an intensity modulated signal, the method disclosed in, for example, the Patent Reference 1 below has been known in which a Differential Multiple-Phase-Shift Keying (DMPSK) signal is converted into an intensity modulated signal and the delay time of the optical interferometer is adjusted such that the average value of the distribution of amplitude of the intensity modulated signal comes to be the maximum.

Patent Reference 1: Japanese Patent Publication No. 2007-181171.

However, the above method requires a longtime to reach a desired amount of delay (i.e., the target value of control).

### SUMMARY

(1) According to an aspect of the embodiment, an apparatus includes an optical receiving apparatus including: an optical interferometer which has a first optical waveguide and a second optical waveguide having light paths different in length and which converts a phase modulated signal received by the optical receiving apparatus into an intensity modulated signal; a controller which controls a phase of the optical interferometer by varying a temperature of the first optical waveguide; a temperature detector which detects the temperature of the first optical waveguide; an optical receiver which receives the intensity modulated signal output from the optical interferometer, converts the intensity modulated signal into an electric signal, and outputs the electric signal; and an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; selects the temperature of the first optical waveguide at which temperature the average photocurrent has an extreme value based on the result of the monitoring; and varies the temperature of the first optical waveguide to the selected temperature.

(2) According to an aspect of the embodiment, an apparatus includes an optical receiving apparatus including: an optical interferometer which has a first optical waveguide and a second optical waveguide having light paths different in length and which converts a phase modulated signal received by the optical receiving apparatus into an intensity modulated signal; a controller which controls a phase of the optical interferometer by varying a temperature of the first optical waveguide; a temperature detector which detects the temperature of the first optical waveguide; an optical receiver which receives the intensity modulated signal output from the optical interferometer, converts the intensity modulated signal into an electric signal, and outputs the electric signal; and an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; selects two temperatures of the first optical waveguide at which temperatures the average photocurrent has an extreme value and another value based on the result of the monitoring; calculates a temperature difference that shifts a phase of the optical interferometer by 45 degrees based on the selected two temperatures; and varies the temperature of the first optical waveguide to a temperature which is higher or lower than the temperature at which the average photocurrent has the extreme value by the calculated temperature difference.

(3) According to an aspect of the embodiment, an apparatus includes an optical receiving apparatus including: an optical interferometer which has a first optical waveguide and a second optical waveguide having light paths different in length and which converts a phase modulated signal received by the optical receiving apparatus into an intensity modulated signal; a controller which controls a phase of the optical interferometer by varying a temperature of the first optical waveguide; a temperature detector which detects the temperature of the first optical waveguide; an optical receiver which receives the intensity modulated signal output from the optical interferometer, converts the intensity modulated signal into an electric signal, and outputs the electric signal; and an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; detects at least four pairs each including a point of the average photocurrent and a temperature of the first optical waveguide corresponding to the point based on the result of the monitoring; calculates the temperature of the first optical waveguide at which temperature the average photocurrent has an extreme value based on the four detected pairs; and varies the temperature of the first optical waveguide to the calculated temperature.

(4) According to an aspect of the embodiment, a method includes a method for optical reception including: converting a received phase modulated signal into an intensity modulated signal by an optical interferometer having a first optical waveguide and a second optical waveguide having light paths different in length; monitoring a temperature of the first optical waveguide and an average photocurrent of the intensity modulated signal output from the optical interferometer while sweeping the temperature of the first optical waveguide in a predetermined range; selecting the temperature of the first optical waveguide at which temperature the average photocurrent has an extreme value based on the result of the monitoring; and varying the temperature of the first optical waveguide to the selected temperature.

(5) According to an aspect of the embodiment, an apparatus includes an optical transmission system including any of the above optical receiving apparatuses and an optical transmitting apparatus which transmits a phase shifted signal to the optical receiving apparatus.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1A is a diagram denoting an example of a phase modulated signal;

FIG. 1B is a diagram denoting an example of a delayed signal;

FIG. 1C is a diagram denoting an example of an intensity modulated signal;

FIG. 2 is a block diagram schematically illustrating an example of the configuration of an optical receiving apparatus;

FIG. 3 is diagram denoting an example of control of the optical receiving apparatus of FIG. 2;

FIG. 4 is a diagram schematically illustrating an example of the configuration of an optical transmission system according to a first embodiment;

FIG. 5 is a block diagram schematically illustrating an optical receiving apparatus included in the optical transmission system of FIG. 4;

FIG. 6 is a graph denoting an example of the difference of the temperature of the optical waveguide and the measured value thereof;

FIG. 7 is a graph denoting an example of control performed by the optical receiving apparatus of FIG. 5;

FIG. 8A is a graph denoting an example of the driving voltage;

FIG. 8B is a graph denoting an example of a variation in the temperature of the optical waveguide;

FIG. 8C is a graph denoting an example of a variation in the average photocurrent;

FIG. 9A is a graph denoting the relationship between sampling interval and the temperature of the optical waveguide of the optical receiving apparatus of FIG. 2;

FIG. 9B is a graph denoting the relationship between sampling interval and the temperature of the optical waveguide of the optical receiving apparatus of FIG. 5;

FIG. 10 is a diagram denoting an example of control performed by an optical receiving apparatus according to a first modification;

FIG. 11 is a diagram denoting an example of control performed by an optical receiving apparatus according to a second modification;

FIG. 12 is a diagram denoting an example of control performed by an optical receiving apparatus according to a third modification;

FIG. 13 is a diagram denoting an example of control performed by an optical receiving apparatus according to a fourth modification;

FIG. 14 is a diagram denoting an example of control performed by an optical receiving apparatus according to a fifth modification;

FIG. 15A is a graph denoting an example of the driving voltage;

FIG. 15B is a graph denoting an example of a variation in the temperature of the optical waveguide;

FIG. 15C is a graph denoting an example of a variation in the average photocurrent;

FIG. 16 is a diagram denoting an example of control performed by an optical receiving apparatus according to a seventh modification;

FIG. 17 is a diagram denoting an example of control performed by an optical receiving apparatus according to an eighth modification;

FIG. 18 is a block diagram schematically illustrating an example of the configuration of the optical receiving apparatus included in the optical transmission system of FIG. 4;

FIG. 19 is a graph denoting a target value of control of the optical receiving apparatus in the optical transmission system of FIG. 4;

FIG. 20A is a graph denoting an example of the driving voltage;

FIG. 20B is a graph denoting an example of a variation in the temperature of the optical waveguide;

FIG. 20C is a graph denoting an example of a variation in the average photocurrent;

FIG. 21 is a diagram denoting an example of control performed by an optical receiving apparatus according to a tenth modification;

FIG. 22 is a diagram denoting an example of control performed by an optical receiving apparatus according to a tenth modification;

FIG. 23 is a diagram denoting an example of control performed by an optical receiving apparatus according to a tenth modification;

FIG. 24 is a diagram denoting an example of control performed by an optical receiving apparatus according to a tenth modification;

FIG. 25 is a diagram denoting an example of control performed by an optical receiving apparatus according to an eleventh modification;

FIG. 26A is a diagram denoting an example of control performed by an optical receiving apparatus according to a twelfth modification; and

FIG. 26B is a diagram denoting an example of control performed by an optical receiving apparatus according to a twelfth modification.

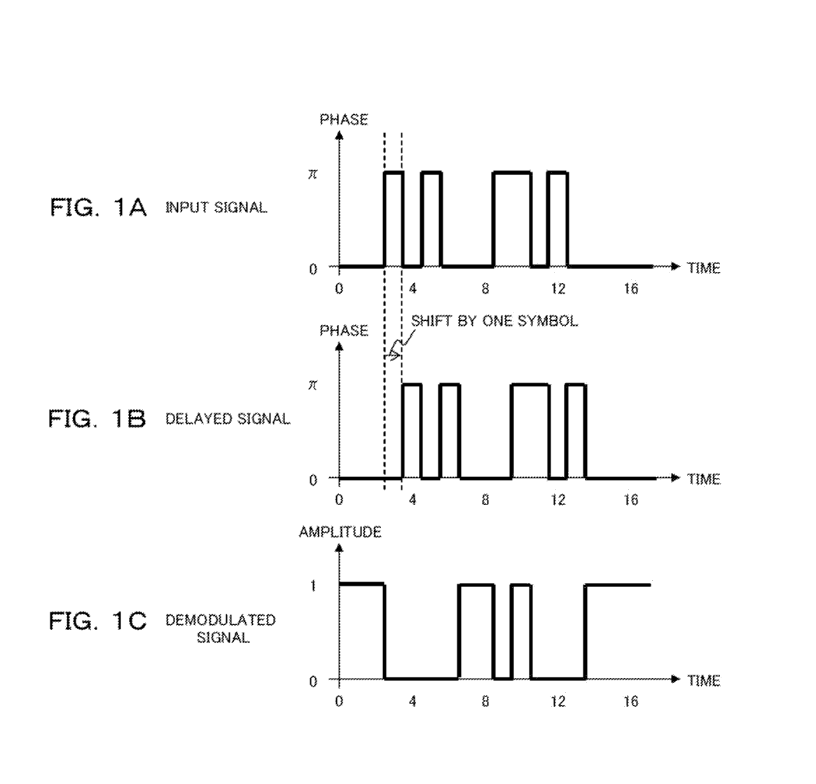

### DESCRIPTION OF EMBODIMENTS

Hereinafter, exemplary embodiments will be described with reference to accompanying drawings. The following exemplary embodiments are merely examples and do not intend to exclude various modifications and variations to the proposed method and/or apparatus that are not specifically described herein. Rather, various modifications or variations may be made to the embodiments (for example, by combining the exemplary embodiments) without departing from the scope and spirit of the proposed method and/or apparatus.

### First Embodiment

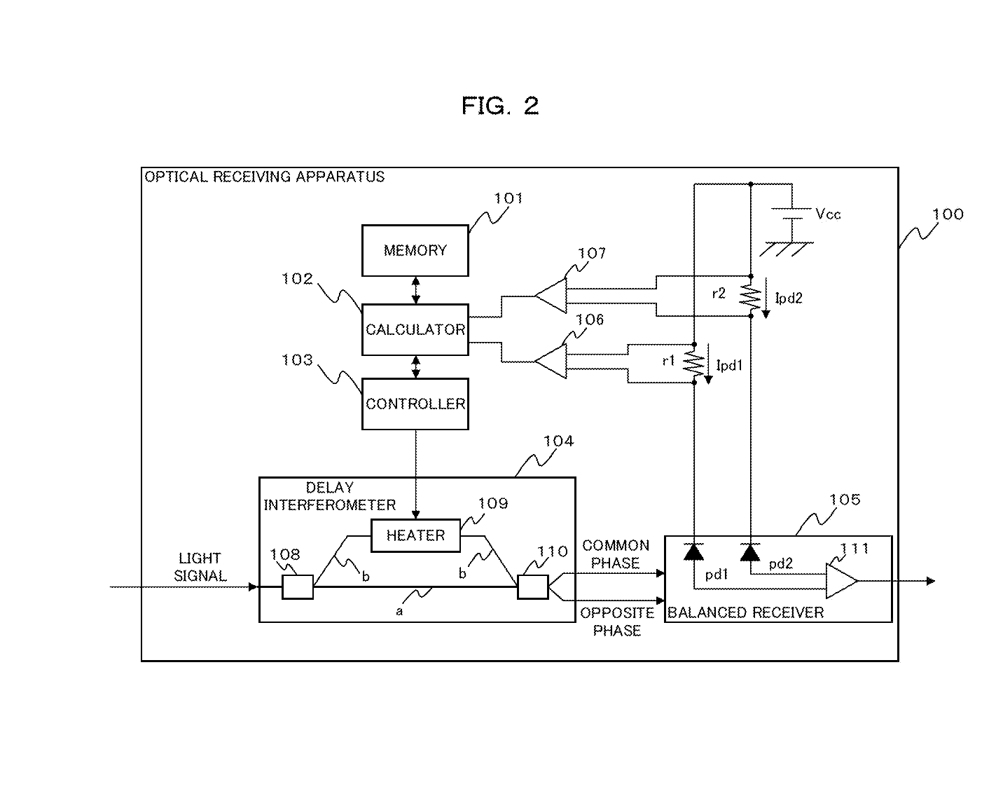

FIG. 2 depicts an example of the configuration of an optical receiving apparatus.

The optical receiving apparatus 100 of FIG. 2 exemplarily includes a memory 101, a calculator 102, a controller 103, a delay interferometer 104, a balanced receiver 105, and differential amplifiers 106 and 107.

The delay interferometer 104 converts a DPSK light signal in the form of a phase modulated signal transmitted from an optical transmitting unit (not illustrated) into an intensity modulated signal. For this purpose, the delay interferometer 104 exemplarily includes an optical coupler 108, two optical waveguides a and b having different light path lengths, a heater 109, and an optical demodulator 110.

The optical coupler 108 bifurcates (branches, divides) a DPSK light signal input into the delay interferometer 104 into components each for one of the optical waveguides a and b, between which a predetermined light path difference is provided. In the example of FIG. 2, the optical waveguide b has a longer light path than that of the optical waveguide a. The difference in light path delays a light signal passing through the optical waveguide b as compared with a light signal passing through the optical waveguide a.

On the optical waveguide b, the heater 109 is disposed which heats the waveguide b under temperature control of the controller 103. Since the refractive index of the optical waveguide b varies with the temperature thereof and the light path length of the optical waveguide b varies with the variation in the refractive index, temperature control with the use of the heater 109 can adjust an amount of delay between a light signal passing through the optical waveguide a and alight signal passing though the optical waveguide b.

The optical demodulator 110, as described above, converts a DPSK light signal in the form of a phase modulated signal into an intensity modulated signal based on the phase relationship between the light signal (input signal) passing through the optical waveguide a and the light signal (delayed signal) passing through the optical waveguide b. The intensity modulate signal (a common phase component and an opposite phase component) obtained by the conversion in the optical demodulator 110 is sent to the balanced receiver 105.

The balanced receiver 105 photoelectrically converts the common phase component (hereinafter also called a positive phase component or a co-phase component) and the opposite phase component (hereinafter also called a negative phase component or a reversed phase component) of the intensity modulated signal received from the delay interferometer 104 and outputs the difference of the converted two electric signals serving as a modulated signal. For this purpose, the balanced receiver 105 exemplarily includes photodiodes pd1 and pd2, and a differential amplifier 111.

The pd1 photoelectrically converts the common phase component of the intensity modulated signal received from the delay interferometer 104 and outputs the resultant electric signal to the differential amplifier 111; and the pd2 photoelectrically converts the opposite phase component of the intensity modulated signal received from the delay interferometer 104 and outputs the resultant electric signal to the differential amplifier 111. The differential amplifier 111 amplifies the difference of the electric signals output from the pd1 and pd2 and outputs the amplified difference to serve as the modulated signal.

Here, a reverse bias voltage Vcc is applied to the pd1 and the pd2 in the example of FIG. 2. Accordingly, through the pd1 and the pd2, average photocurrents Ipd1 and Ipd2 respectively flow which correspond to the intensities of the received light of the common phase component and the opposite phase component, respectively.

The differential amplifier 106 amplifies the difference in voltage between both ends of a resistor r1, which is coupled to the pd1 and the resistance of which is known, and sends the amplified difference to the calculator 102; and similarly, the differential amplifier 107 amplifies the difference in voltage between both ends of a resistor r2, which is coupled to the pd2 and the resistance of which is known, and sends the amplified difference to the calculator 102.

The calculator 102 calculates the Ipd1 and the Ipd2 based on the voltage differences of both ends of the resistors r1 and r2 received from the differential amplifiers 106 and 107, and detects (obtains) a heater driving voltage to be applied to the heater 109 from the controller 103. The results of the calculation and the detection (obtaining) are input into the memory 101 by the calculator 102.

The memory 101 stores the Ipd1, the Ipd2, and the heater driving voltage in a table in association with one another.

The calculator 102 retrieves (detects) a value (target value of control) of the heater driving voltage at which the Ipd1 has a local maximum value (or the Ipd2 has a local minimum value) based on the table stored in the memory 101, and notifies the result of the retrieval to the controller 103.

The controller 103 applies, to the heater 109, a heater driving voltage based on the target value of control notified from the calculator 102 and thereby controls the temperature of the heater 109 such that the Ipd1 takes the maximum value.

In order to determine the target value of control, the optical receiving apparatus 100 stepwisely varies the heater driving voltage at predetermined width interval (step) (i.e., dithering), detects average photocurrents Ipd1 and Ipd2 of the pd1 and the pd2, which currents vary with the above stepwise variation, and retrieves a heater driving voltage at which the Ipd1 has a local maximum value (or the Ipd2 has a local minimum value).

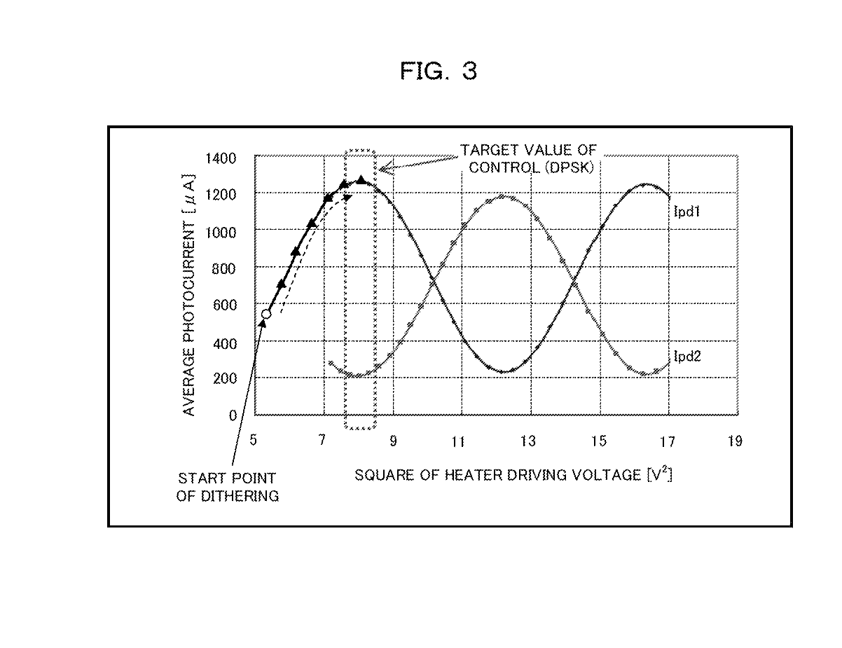

Here, FIG. 3 denotes an example of the relationship between the square [v²] of the heater driving voltage and the average photocurrent [μA]. As depicted in FIG. 3, in demodulation of a DPSK light signal, for example, a heater driving voltage at which the Ipd1 has a local maximum value is identical to a heater driving voltage at which the Ipd2 has a local minimum value. The value at the coincidence is regarded as the target value of control of the heater driving voltage.

For example, the optical receiving apparatus 100 stepwisely varies the heater driving voltage at predetermined intervals from the star point of dithering represented by the white circle in FIG. 3 (see the broken arrow in FIG. 3). At that time, the temperature of the heater 109 varies in arrear of the start of the variation in heater driving voltage. Therefore, the optical receiving apparatus 100 waits until the temperature of the heater 109 is stabilized after the variation in the heater driving voltage and then measures the Ipd1 and the Ipd2.

While the measured Ipd1 is judged not to be a local maximum value (or the measured Ipd2 is judged not to be a local minimum value), the optical receiving apparatus 100 repeats a series of process of: varying the heater driving voltage at predetermined step intervals, waiting until the temperature of the heater 109 is stabilized, and measuring the Ipd1 and the Ipd2. In the example of FIG. 3, the above procedure is repeated at the total seven points including the dithering start point and six control points represented by the black triangle in the drawing.

In due course, when the measured Ipd1 is judged to be a local maximum value (or the measured Ipd2 is judged to be a local minimum value), the optical receiving apparatus 100 detects the heater driving voltage (i.e., the target value of control) corresponding to the average photocurrent and controls the temperature of the heater 109 with the use of the detected heater driving voltage.

However, since it takes (in the order of) several seconds for response of the heater 109 (that is, until the temperature thereof becomes stable), the above method in which average photocurrents are detected after waiting until the temperature of the heater 109 becomes stable for each step of dithering requires a long time to reach the target value of control.

In addition, one of the solutions to the improvement in the retrieving accuracy for the target value of control is to make the dithering interval (the variation widths in the heater driving voltage) be small. However, a smaller interval takes a larger time to reach the target value of control.

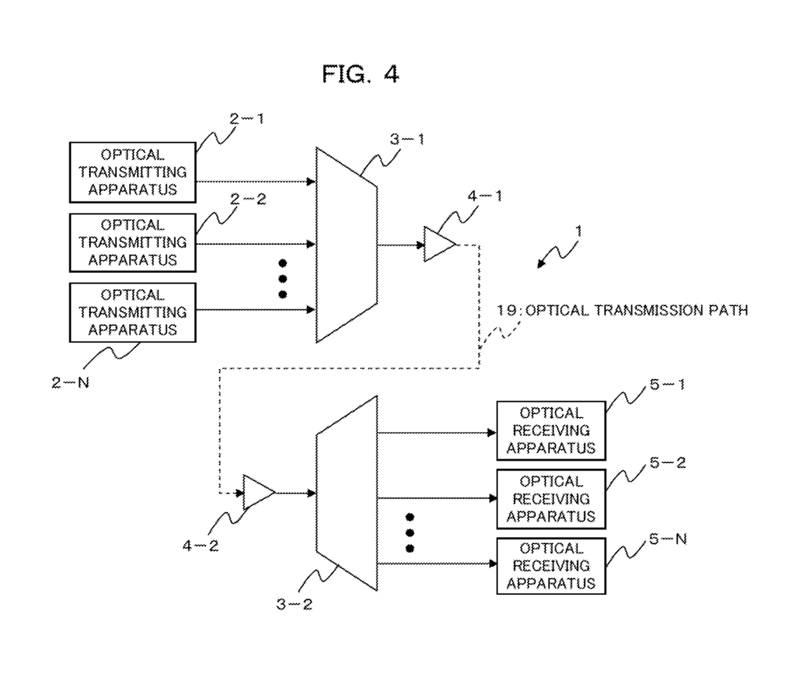

FIG. 4 is a block diagram schematically illustrating an example of the configuration of an optical transmission system according to the first embodiment considering the above problem.

An optical transmission system 1 of FIG. 4 exemplarily includes optical transmitting apparatuses 2-1, . . . , 2-N (N is a natural number), WDM (Wavelength Division Multiplexing) units 3-1 and 3-2, optical amplifiers 4-1 and 4-2, an optical transmission path 19, and optical receiving apparatuses 5-1, . . . , 5-N. If there is no requirement to discriminate the optical transmitting apparatuses 2-1, . . . , 2-N from one another, each optical transmitting apparatus is represented by reference number 2. Similarly, if there is no requirement to discriminate the optical receiving apparatuses 5-1, . . . , 5-N from one another, each optical receiving apparatus is represented by reference number 5. The number of optical transmitting apparatuses 2 and the number of optical receiving apparatuses 5 are not limited to those of FIG. 4. When the number N is equal to one (N=1), the WDM units 3-1 and 3-2 may be omitted.

Here, each optical transmitting apparatus 2 converts a data signal to be transmitted into a light signal having a predetermined wavelength, performs phase modulation on the light signal, and outputs the phase-modulated light signal to the WDM unit 3-1. The phase modulation may be exemplified by schemes of DPSK and Differential Quadrature Phase Shift Keying (DQPSK), but the first embodiment assumes to adopt the DPSK.

The WDM unit 3-1 performs wavelength multiplexing DPSK light signals received from the optical transmitting apparatuses 2 and outputs the wavelength-multiplexed light signal to the optical amplifier 4-1.

The optical amplifier 4-1 amplifies the wavelength-multiplexed light signal received from the WDM unit 3-1 and outputs the amplified signal to the optical transmission path 19.

The optical transmission path 19 is a medium, such as an optical fiber, which is capable of transmitting a light signal and may be interposed by a relay, an amplifier and others.

The optical amplifier 4-2 amplifies the wavelength multiplexed light signal transmitted through the optical transmission path 19 from the optical amplifier 4-1, and outputs the amplified signal to the WDM unit 3-2.

The WDM unit 3-2 performs wavelength division on the wavelength multiplexed light signal input from the optical amplifier 4-2 and outputs the resultant demultiplexed signals to respective optical receiving apparatuses 5.

Each optical receiving apparatus 5 demodulates the DPSK signal which is phase modulated and received from the WDM unit 3-2 into an intensity modulated signal.

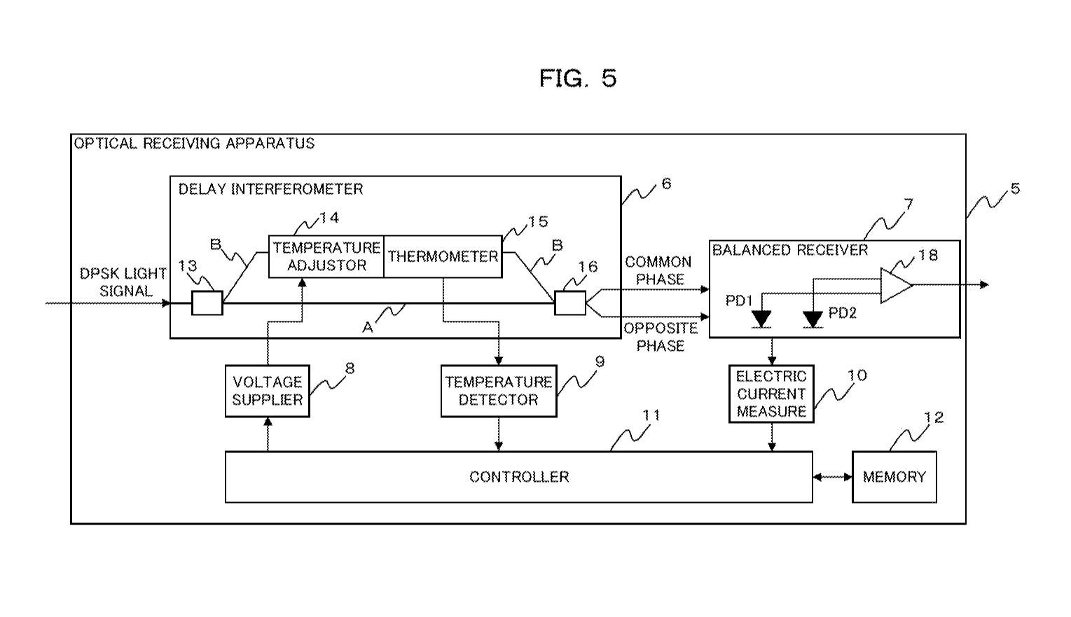

Here, FIG. 5 illustrates an example of the configuration of the optical receiving apparatus 5.

The optical receiving apparatus 5 in FIG. 5 exemplarily includes a delay interferometer 6, a balanced receiver 7, a voltage supplier 8, a temperature detector 9, an electric current measure 10, a controller 11, and a memory 12.

The delay interferometer (light interferometer) 6 converts a DPSK signal in the form of a phase modulated signal transmitted from an optical transmitting apparatus 2 into an intensity modulated signal. For this purpose, the delay interferometer 6 exemplarily includes an optical coupler 13, two optical waveguides A and B having different light path lengths, a temperature adjustor 14, a thermometer 15, and an optical demodulator 16.

The optical coupler 13 branches a DPSK light signal input into the delay interferometer 6 into components each for one of the optical waveguides A and B, between which a predetermined light path difference is provided. In the example of FIG. 5, the optical waveguide B has a longer light path than that of the optical waveguide A. The difference in the light path delays a light signal passing through the optical waveguide B by a predetermined amount (e.g., by one symbol) as compared with alight signal passing through the optical waveguide A.

On the optical waveguide B, the temperature adjustor 14 and the thermometer 15 are disposed. The temperature adjustor 14 heats or cools the optical waveguide B in accordance with a driving voltage applied by the voltage supplier 8 so that the temperature of the optical waveguide b varies. The temperature adjustor 14 may be formed of a heater, a cooling device (e.g., a Peltier device) or a combination of a heater and a cooling device. The temperature adjustor 14 varies the temperature of the optical waveguide B, which further varies the refractive index thereof. Thereby, the delay interferometer 6 can adjust an amount of delay between a light signal passing through the optical waveguide A and a light signal passing though the optical waveguide B.

The voltage supplier 8 operates under control of the controller 11 and supplies the temperature adjustor 14 of a driving voltage to vary the temperature of the optical waveguide B.

The thermometer 15 measures the temperature of the optical waveguide B or the temperature of the temperature adjustor 14, and outputs the result of the measurement to the temperature detector 9.

The temperature detector 9 measures the temperature of the optical waveguide B based on the result of the measurement by the thermometer 15. For example, the temperature detector 9 samples values measured by the thermometer 15 at predetermined sampling intervals and outputs the result of the sampling to the controller 11.

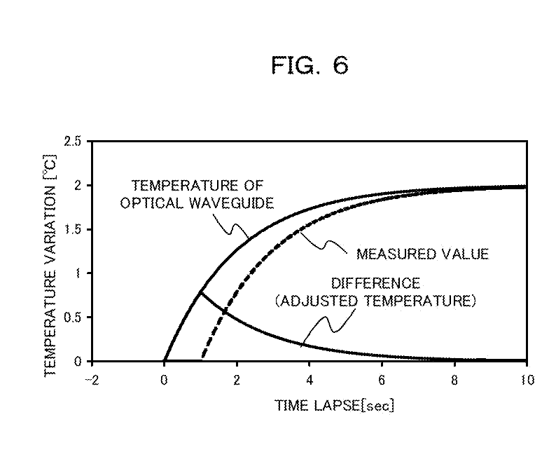

The temperature detector 9 may correct the result of the measurement in the thermometer 15 and thereby detect the temperature of the optical waveguide B. Specifically, when the temperature of the optical waveguide B has a difference (an error) from the measured value by the thermometer 15 as the example of FIG. 6, the temperature detector 9 measures the difference in advance and adds (or subtracts) the difference (correcting temperature) measured in advance to (or from) the measured value by the thermometer 15, so that the accurate temperature of the optical waveguide B can be calculated.

The optical demodulator 16 converts an input light signal in the form of a phase modulated signal into an intensity modulated signal based on the relationship of the phase between a light signal (input signal) propagating through the optical waveguide A and a light signal (delayed signal) propagating through optical waveguide B. For example, the optical demodulator 16 causes the input signal to interfere with the delayed signal and obtains an intensity modulated signal by, if the input signal and the delayed signal are in phase, constructive interference or by, if the input signal and the delayed signal are out of phase, destructive interference. The intensity modulated signal (the common phase component and the opposite phase component) as the result of the conversion by the optical demodulator 16 is output to the balanced receiver 7.

The balanced receiver (optical receiver) 7 receives the common phase component and the opposite phase component of the intensity modulated signal output from the delay interferometer 6 and performs photoelectric conversion on the components into electric signals. In addition, the balanced receiver 7 outputs the difference between the electric signals obtained through the photoelectric conversion as a demodulated signal. For this purpose, the balanced receiver 7 exemplarily includes photodiodes PD1 and PD2 and a differential amplifier 18.

The PD1 photoelectrically converts the common phase component of the intensity modulated signal received from the delay interferometer 6 and outputs the resultant electric signal to the differential amplifier 18; and the PD 2 photoelectrically converts the opposite phase component of the intensity modulated signal received from the delay interferometer 6 and outputs the resultant electric signal to the differential amplifier 18.

The differential amplifier 18 amplifies the difference between the electric signals output from the PD1 and PD2 and outputs the amplified difference serving as the modulated signal to an external unit.

The electric current measure 10 measures at least one of the average photocurrent IPD1 of the common phase component of the intensity modulated signal received by the PD1 in the balanced receiver 7 and the average photocurrent IPD2 of the opposite phase component of the intensity modulated signal received by the PD2 in the balanced receiver 7. The electric current measure 10 samples values of the IPD1 and the IPD2 at predetermined sampling intervals and outputs the result of sampling to the controller 11. Here, the electric current measure 10 may detect the average photocurrents IPD1 and IPD2 through measuring the difference in voltage between both ends of a resistor R1 which is coupled to the PD1 and the resistance of which is known and the difference in voltage between both ends of a resistor R2 which is coupled to the PD2 and the resistance of which is known, respectively.

The controller 11 varies the temperature of the optical waveguide B through the use of the voltage supplier 8 and the temperature adjustor 14 so that the phase (an amount of delay) of the delay interferometer 6 is controlled.

In the illustrated example, the controller 11 controls the voltage that the voltage supplier 8 supplies to the temperature adjustor 14 and sweeps the temperature of the optical waveguide B in a predetermined range. Further, the controller 11 monitors the result of the sampling by the temperature detector 9 and the result of the sampling by the electric current measure 10 while sweeping the temperature of the optical waveguide B in the predetermined range, and creates a table in which the temperature of the optical waveguide B is associated with the IPD1 and the IPD2 based on the results of the samplings. The table created by the controller 11 is stored into the memory 12, which serves as a memory to store therein the created table. The table may be created by the controller 11 each time the delay interferometer 6 is activated or may be updated at regular or irregular intervals.

The controller 11 detects (selects) the temperature of the optical waveguide B at which the IPD1 takes a local maximum value and controls the voltage supplier 8 and the temperature adjustor 14 such that the temperature of the optical waveguide B becomes the selected temperature.

In other words, the controller 11 functions as an example of a controller which monitors the result of the detection by the temperature detector 9 and the result of the measurement by the electric current measure 10 while sweeping the temperature of the optical waveguide B in the predetermined range; selects the temperature of the optical waveguide B at which the average photocurrents IPD1 and IPD2 in the balanced receiver 7 have an extreme value based on the result of the monitoring and the result of the measuring; and varies the temperature of the optical waveguide B to the selected temperature.

Further, the controller 11 may control the voltage supplier 8 and the temperature adjustor 14 in order to vary the temperature of the optical waveguide B through Proportional Integral Derivative (PID) control. The use of PID control makes it possible to vary the temperature of the optical waveguide B to a desired value faster.

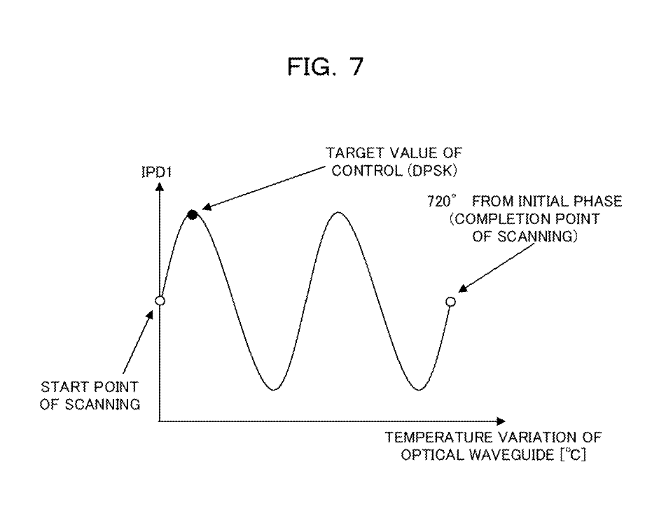

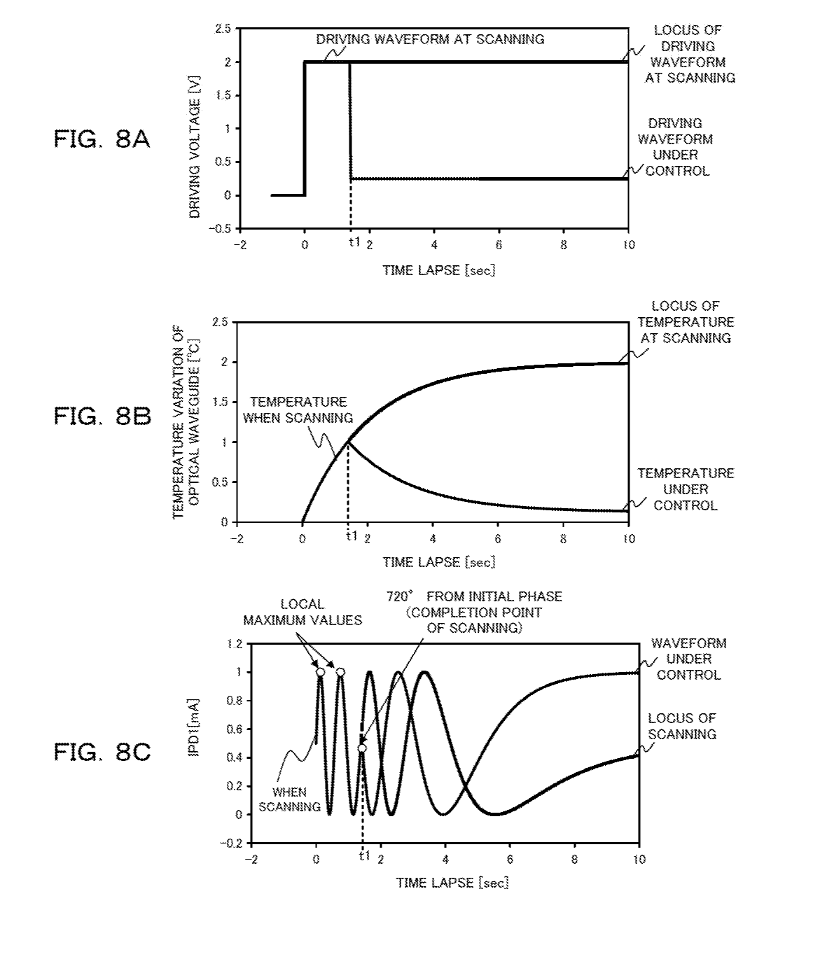

Here, description will now be made in relation to an example of operation performed by the optical receiving apparatus 5 with reference to FIGS. 7, 8A through 8C.

For example, when the controller 11 monitors the average photocurrent IPD1 of the common phase component while continuously varying (sweeping) the temperature of the optical waveguide B, the relationship between the temperature variation [° C.] of the optical waveguide B and the IPD1 [mA] varies in a sine wave.

In this example, the controller 11 continuously varies (sweeps) the temperature of the optical waveguide B in a range in which the phase of the IPD1 shifts by 720 degrees (completion point of scanning) from the initial phase (start point of scanning). In other words, the controller 11 continuously varies (sweeps) the temperature of the optical waveguide Bin a range in which the phase of the delay interferometer 6 shifts by at least 720 degrees from the initial phase.

In this case, two points are detected at which the IPD1 has local maximum values between which a value having a smaller temperature variation from the initial temperature of the optical waveguide B can be regarded as the target value of control of the temperature of the optical waveguide B. Thereby, it is possible to reduce the driving voltage that the voltage supplier 8 supplies to the delay interferometer 6 when the delay interferometer 6 is activated so that power consumption can be saved. Alternatively, the controller 11 may regard the other local maximum value as the target value of control of the temperature of the optical waveguide B and control the temperature of the optical waveguide B. For example, selection of the other local maximum value (having a larger variation in temperature from the initial temperature of the optical waveguide B) as the target value of control can reduce an amount of variation in temperature from the completion point of scanning to the target value of control, so that time required for temperature control of the optical waveguide B can be reduced.

Here, FIG. 8A illustrates an example of the driving voltage supplied from the voltage supplier 8.

When the voltage supplier 8 applies a step voltage having amplitude of 2 V (see “driving waveform at scanning” and “locus of the driving waveform at scanning”) to the temperature adjustor 14 as depicted in FIG. 8A, the temperature of the optical waveguide B transitively varies as depicted in FIG. 8B (see “temperature when scanning” and “locus of temperature at scanning”). In accordance with the temperature variation of the optical waveguide B, the IPD1 varies as depicted in the example of FIG. 8C (see “when scanning” and “locus of scanning”).

In the illustrated example, the scan by the controller 11 is completed at a time point t1 (where t1 is a natural number) when the phase of the IPD1 is shifted by 720 degrees from the initial phase, and the temperature of the optical waveguide B at which the IPD1 has a local maximum value is detected (selected) from the result of the scanning.

After the time point t1, the controller 11 controls the driving voltage that the voltage supplier 8 applies to the temperature adjustor 14 such that the temperature of the optical waveguide B becomes the selected temperature (see “driving waveform under control” in FIG. 8A). In accordance with the control, the temperature of the optical waveguide B converges on the selected temperature after the time point t1 (see “temperature under control” in FIG. 8B) and the IPD1 converges on the local maximum value (see “waveform under control” in FIG. 8C).

As the above, the optical receiving apparatus 5 of the first embodiment can detect a target value of control (e.g., the temperature of the optical waveguide B at which the IPD1 has a local maximum value) through a single-time control (sweep) on the temperature of the optical waveguide B, so that the target value of control can be searched in a shorter time. Furthermore, it is possible to reduce time required for adjustment of an amount of delay in the delay interferometer 6, so that the activation speed of the delay interferometer 6 can be improved.

In order to detect a local maximum value of the IPD1 with high accuracy, the illustrated example may set the sampling interval of the average photocurrent to be in the range of from several milliseconds to about 50 milliseconds.

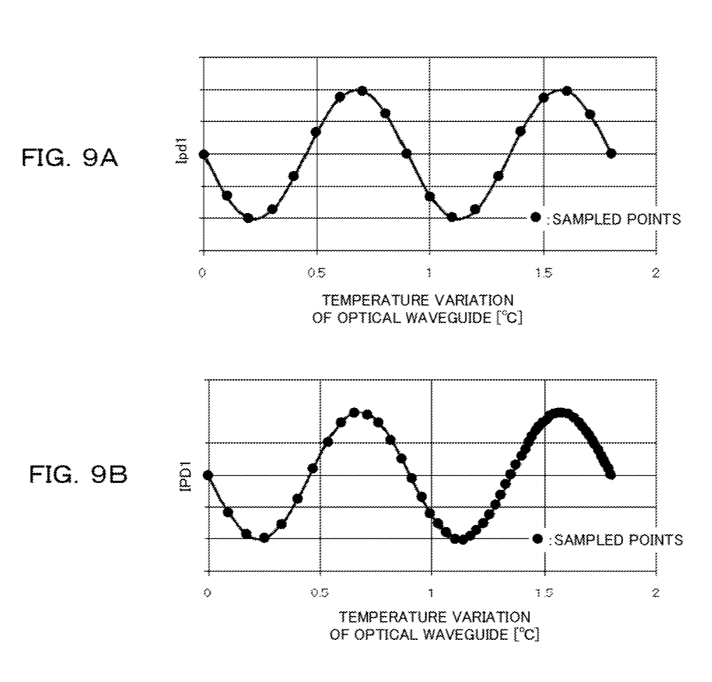

Here, FIG. 9A illustrates the relationship between the sampling interval of the optical receiving apparatus 100 of the example FIG. 2 and the temperature variation of the optical waveguide b; and FIG. 9B illustrates the relationship between the sampling interval of the optical receiving apparatus 5 of the example FIG. 5 and the temperature variation of the optical waveguide B.

Since the optical receiving apparatus 100 detects (samples) the average photocurrent after waiting until the temperature of the heater 109 becomes stable, the cycle (sampling interval) for photocurrent detection is set to be from about 4 seconds to about 5 seconds. As a consequence, the example of FIG. 9A detects the target value of control (a local maximum value) in the eighth search, which means that it takes from about 32 seconds to about 40 seconds to detect the target value of control.

In addition, when an amount of delay (an amount of phase control) required for the delay interferometer 104 is different with the wavelength of a signal light input into the optical receiving apparatus 100, the time required for the detection is therefore different with the wavelength of the input signal. Consequently, a time required for activation of the delay interferometer 104 may be different with the wavelength of the input signal. For the above, in an optical transmission system including a number of delay interferometers 104 (optical receiving apparatuses 100), delay of activation of one of the delay interferometers 104 results in delay of activation of the entire system.

Conversely, the optical receiving apparatus 5 of the first embodiment continuously varies (sweeps) the temperature of the optical waveguide B until the phase of the IPD1 shifts by 720 degrees and detects the temperature (the target value of control) of the optical waveguide B at which the IPD1 has a local maximum value during the sweep. Accordingly, there is no need to wait unit the temperature of the optical waveguide B becomes stable when values of the average photocurrent are sampled.

Even when the sampling interval by the electric current measure 10 is set to be about 50 milliseconds in order to detect a local maximum value of the IPD1 with high accuracy, it takes 5 seconds to complete the scan in the example of FIG. 9B, so that the time required for the detection of the target value of control can be greatly reduced as compared to the optical receiving apparatus 100. Further, even when the sampling interval of the electric current measure 10 is set to be shorter with the intention of detecting an accurate target value of control, the time period required for completion of scanning can be constant.

Since the phase difference of the IPD1 between the initial phase and the target value of control is 180 degrees at the maximum, the scanning step width (the dithering width) that shifts the phase of the IPD1 by 5 degrees causes the heater 109 to vary the temperature 36 times in the optical receiving apparatus 100. In the meantime, the temperature adjustor 14 varies the temperature only twice regardless of the phase difference of the IPD1 between the initial phase and the target value of control, so that the optical receiving apparatus 5 can greatly reduce the number of times of variation of the temperature as compared with the optical receiving apparatus 100.

Further, for example, since it takes about 5 seconds to vary the temperature of the optical waveguide B to the target value of control, the time required for activation of the delay interferometer 6 can be greatly reduced as compared with the optical receiving apparatus 100.

Still further, even when signal light that is to be input into the optical receiving apparatus 5 varies, the time required for detection of the target value of control is approximately constant, so that the time for activation of the delay interferometer 6 is constant for wavelength of the input signal light.

Scanning of the target value of control each time the delay interferometer 6 is activated makes it possible to flexibly adopt the variation in amount of phase control caused by the external environment of the system.

The temperature adjustor 14 and the thermometer 15 configured into a single united form can reduce the cost and the size for the apparatus.

### (b) First Modification

In the above first embodiment, the temperature of the optical waveguide B is controlled such that the IPD1 has a local maximum value. Alternatively, the controller 11 may control the temperature of the optical waveguide B such that the average photocurrent (IPD2) of the opposite phase of the intensity modulated signal has a local minimum value as performed in the first modification.

In this modification, the controller 11 continuously varies (sweeps) the temperature of the optical waveguide B in a range in which the phase of the IPD2 shifts by 720 degrees (completion point of scanning) from the initial phase (start point of scanning). In other words, the controller 11 sweeps the temperature of the optical waveguide B in a range in which the phase of the delay interferometer 6 shifts by at least 720 degrees from the initial phase.

In this case, two points are detected at which the IPD2 has local minimum values between which a value having a smaller temperature variation from the initial temperature of the optical waveguide B can be regarded as the target value of control of the temperature of the optical waveguide B. Thereby, it is possible to reduce the driving voltage that the voltage supplier 8 supplies to the delay interferometer 6 when the delay interferometer 6 is activated so that power consumption can be saved. Alternatively, the controller 11 may regard the other local minimum value as the target value of control of the temperature of the optical waveguide B and control the temperature of the optical waveguide B accordingly. For example, selection of the other local minimum value (having a larger variation in temperature from the initial temperature of the optical waveguide B) as the target value of control can reduce an amount of variation in temperature from the completion point of scanning to the target value of control, so that time required for temperature control of the optical waveguide B can be reduced.

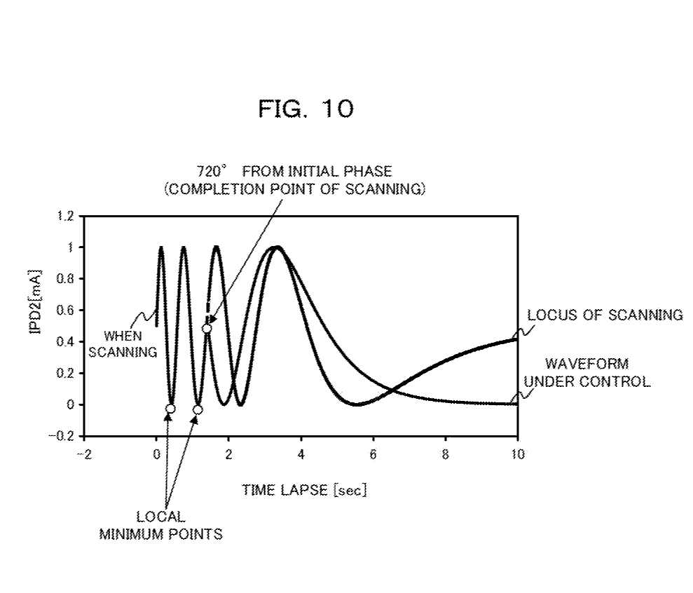

Here, FIG. 10 illustrates an example of the locus of the IPD2.

For example, temperature of the optical waveguide B transitively varies when the voltage supplier 8 applies a step voltage having amplitude of 2 V to the temperature adjustor 14. In accordance with the temperature variation of the optical waveguide B, the IPD2 varies as depicted in the example of FIG. 10 (see “when scanning” and “locus of scanning”).

In the illustrated example, the scan by the controller 11 is completed when the phase of the IPD2 is shifted by 720 degrees from the initial phase, and the temperature of the optical waveguide B at which the IPD2 has a local minimum value is detected (selected) from the result of the scanning.

After the completion of scanning, the controller 11 controls the driving voltage that the voltage supplier 8 supplies to the temperature adjustor 14 such that the temperature of the optical waveguide B becomes the selected temperature. In accordance with the control, the temperature of the optical waveguide B converges on the selected temperature after the completion of the scanning and the IPD2 converges on the local minimum value (see “waveform under control” in FIG. 10).

As the above, the same advantages can be ensured when the temperature of the optical waveguide B is controlled such that the IPD2 has a local minimum value.

### (c) Second Modification

Further alternatively, the controller 11 may control the temperature of the optical waveguide B such that the difference (IPD1-IPD2) between the average photocurrent (IPD1) of the common phase component of the intensity modulated signal and the average photocurrent (IPD2) of the opposite phase component of the intensity modulated signal has a local maximum value as performed in the second modification.

In the illustrated example, the controller 11 continuously varies (sweeps) the temperature of the optical waveguide B in a range in which the phase of the difference (IPD1-IPD2) shifts by 720 degrees (completion point of scanning) from the initial phase (start point of scanning). In other words, the controller 11 continuously varies (sweeps) the temperature of the optical waveguide B in a range in which the phase of the delay interferometer 6 shifts by at least 720 degrees from the initial phase.

In this case, two points are detected at which the difference (IPD1-IPD2) has local maximum values between which a value having a smaller temperature variation from the initial temperature of the optical waveguide B can be regarded as the target value of control of the temperature of the optical waveguide B. Thereby, it is possible to reduce the driving voltage that the voltage supplier 8 supplies to the delay interferometer 6 when the delay interferometer 6 is activated so that power consumption can be saved. Alternatively, the controller 11 may regard the other local maximum value as the target value of control of the temperature of the optical waveguide B and control the temperature of the optical waveguide B accordingly. For example, selection of the other local maximum value (having a larger variation in temperature from the initial temperature of the optical waveguide B) as the target value of control can reduce an amount of variation in temperature from the completion point of scanning to the target value of control, so that time required for temperature control of the optical waveguide B can be reduced.

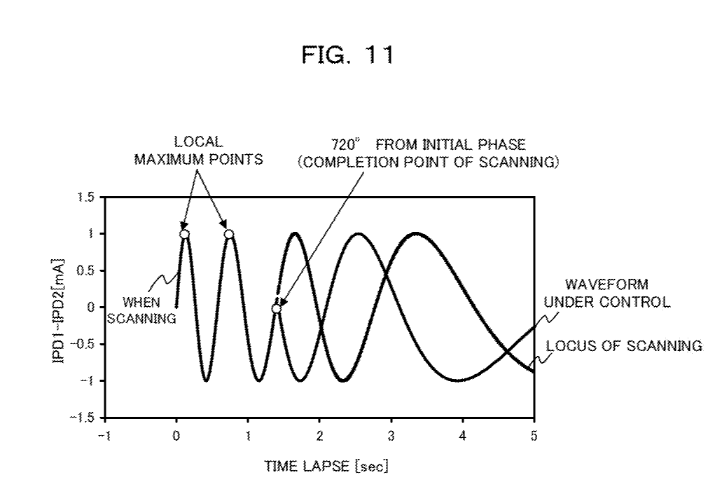

Here, FIG. 11 denotes an example of the locus of the difference (IPD1-IPD2).

The temperature of the optical waveguide B transitively varies when the voltage supplier 8 supplies a step voltage having amplitude of 2 V to the temperature adjustor 14, for example. In accordance with the temperature variation of the optical waveguide B, the difference (IPD1-IPD2) varies as depicted in the example of FIG. 11 (see “when scanning” and “locus of scanning”).

In the illustrated example, the scan by the controller 11 is completed when the phase of the difference (IPD1-IPD2) is shifted by 720 degrees from the initial phase, and the temperature of the optical waveguide B at which the difference (IPD1-IPD2) has a local maximum value is detected (selected) from the result of the scanning.

After the completion of scanning, the controller 11 controls the driving voltage that the voltage supplier 8 supplies to the temperature adjustor 14 such that the temperature of the optical waveguide B becomes the selected temperature. In accordance with the control, the temperature of the optical waveguide B converges on the selected temperature after the completion of scanning and the difference (IPD1-IPD2) converges on the local maximum value (see “under control” in FIG. 11).

As the above, the same advantages can be ensured when the temperature of the optical waveguide B is controlled such that the difference (IPD1-IPD2) has a local minimum value.

### (d) Third Modification

As performed in this example, the controller 11 may sweep the temperature of the optical waveguide B in a range in which the phase of the IPD1 (the phase of the delay interferometer 6) shifts by at least 360 degrees from the initial phase to detect a temperature of the optical waveguide B at which the IPD1 has a local maximum value and control the temperature of the optical waveguide B accordingly.

In the illustrated example, the controller 11 continuously varies (sweeps) the temperature of the optical waveguide B in a range in which the phase of the IPD1 shifts by 360 degrees (completion point of scanning) from the initial phase (start point of scanning).

The sweep detects a single point at which the IPD1 has a local maximum value and the controller 11 controls the temperature of the optical waveguide B, regarding the detected point as the target value of control.

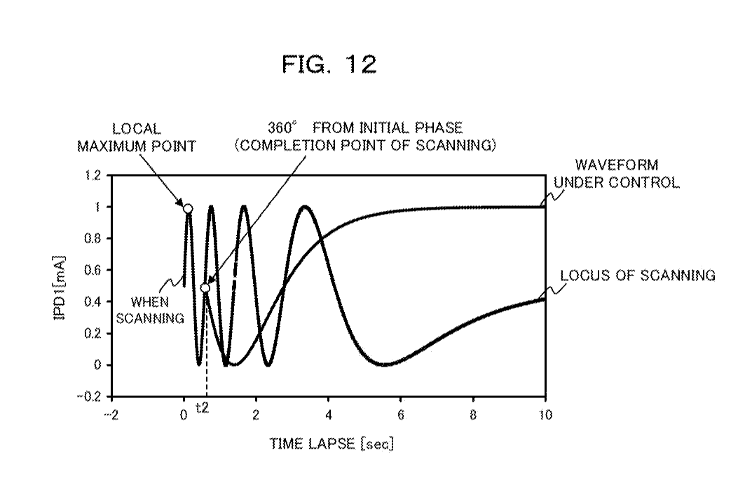

For example, the temperature of the optical waveguide B transitively varies when the voltage supplier 8 applies a step voltage having amplitude of 2 V to the temperature adjustor 14. In accordance with the temperature variation of the optical waveguide B, the IPD1 varies as depicted in the example of FIG. 12 (see “when scanning” and “locus of scanning”).

In the illustrated example, the scan by the controller 11 is completed at time point t2 (where t2 is a natural number) when the phase of the IPD1 is shifted by 360 degrees from the initial phase, and the temperature of the optical waveguide B at which the IPD1 has a local maximum value is detected (selected) from the result of the scanning.

After the time point t2, the controller 11 controls the driving voltage that the voltage supplier 8 supplies to the temperature adjustor 14 such that the temperature of the optical waveguide B becomes the selected temperature. In accordance with the control, the temperature of the optical waveguide B converges on the selected temperature after the time point t2 and the IPD1 converges on the local maximum value (see “waveform under control” in FIG. 12).

As the above, also when the range (sweep range) in which the temperature of the optical waveguide B varies is set to be the variation in phase of the delay interferometer 6 by 360 degrees from the initial phase, the same advantages as the first embodiment can be ensured because a target value of control of the temperature of the optical waveguide B can be detected at which the IPD1 has a local maximum value.

Further, since this modification has a smaller width (sweep range) of the variation in temperature of the optical waveguide B than those of the first embodiment and the first and the second modifications, it is possible to reduce time required for detection of the target value of control, further improving the speed of activation of the delay interferometer 6.

### (e) Fourth Modification

As performed in this example, the controller 11 may sweep the temperature of the optical waveguide B in a range in which the phase of the IPD2 (the phase of the delay interferometer 6) shifts by at least 360 degrees from the initial phase to detect a temperature of the optical waveguide B at which the IPD1 has the local minimum value and control the temperature of the optical waveguide B accordingly.

In the illustrated example, the controller 11 continuously varies (sweeps) the temperature of the optical waveguide B in a range in which the phase of the IPD2 shifts by 360 degrees (completion point of scanning) from the initial phase (start point of scanning).

The sweep detects a single point at which the IPD2 has a local minimum value and the controller 11 controls the temperature of the optical waveguide B, regarding the detected point as the target value of control.

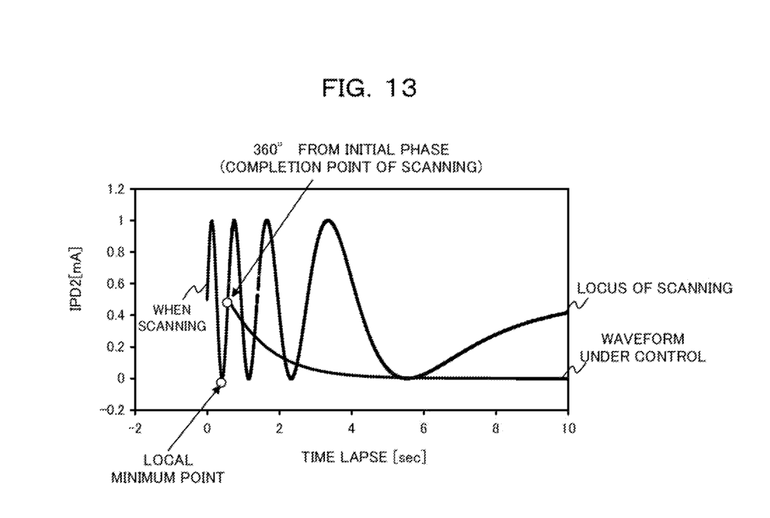

For example, temperature of the optical waveguide B transitively varies when the voltage supplier 8 applies a step voltage having amplitude of 2 V to the temperature adjustor 14. In accordance with the temperature variation of the optical waveguide B, the IPD2 varies as depicted in the example of FIG. 13 (see “when scanning” and “locus of scanning”).

In the illustrated example, the scan by the controller 11 is completed when the phase of the IPD2 is shifted by 360 degrees from the initial phase, and the temperature of the optical waveguide B at which the IPD2 has a local minimum value is detected (selected) from the result of the scanning.

After the completion of scanning, the controller 11 controls the driving voltage that the voltage supplier 8 supplies to the temperature adjustor 14 such that the temperature of the optical waveguide B becomes the selected temperature. In accordance with the control, the temperature of the optical waveguide B converges on the selected temperature after the completion of scanning and the IPD2 converges on the local minimum value (see “waveform under control” in FIG. 13).

As the above, also when the range (sweep range) in which the temperature of the optical waveguide B varies is set to a range in which the phase of the delay interferometer 6 shifts by at least 360 degrees from the initial phase, the same advantages as the third modification can be ensured by detecting a target value of control of the temperature of the optical waveguide B at which the IPD2 has a local minimum value.

### (f) Fifth Modification

Alternatively, the controller 11 may sweep the temperature of the optical waveguide B in a range in which the phase of the difference (IPD1-IPD2) (the phase of the delay interferometer 6) shifts by at least 360 degrees from the initial phase to detect a temperature of the optical waveguide B at which the difference (IPD1-IPD2) has a local maximum value and control the temperature of the optical waveguide B accordingly.

In the illustrated example, the controller 11 continuously varies (sweeps) the temperature of the optical waveguide B in a range in which the phase of the difference (IPD1-IPD2) shifts by 360 degrees (completion point of scanning) from the initial phase (start point of scanning).

The sweep detects a single point at which the difference (IPD1-IPD2) has a local maximum value and the controller 11 controls the temperature of the optical waveguide B, regarding the detected point as the target value of control.

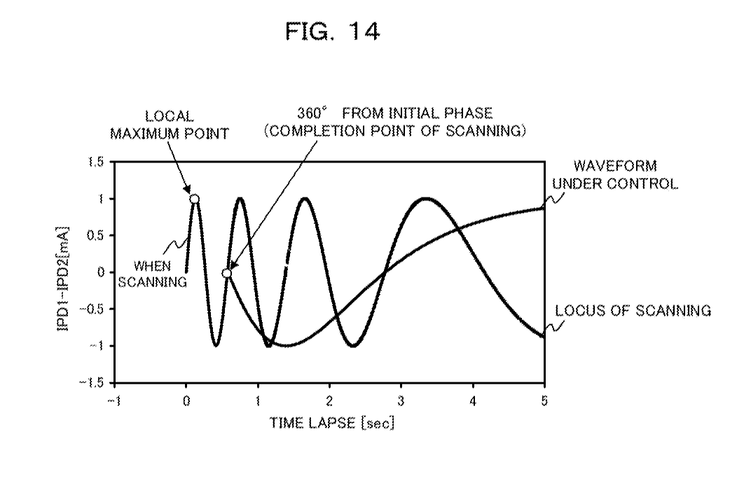

For example, temperature of the optical waveguide B transitively varies when the voltage supplier 8 applies a step voltage having amplitude of 2 V to the temperature adjustor 14. In accordance with the temperature variation of the optical waveguide B, the difference (IPD1-IPD2) varies as depicted in the example of FIG. 14 (see “when scanning” and “locus of scanning”).

In the illustrated example, the scan by the controller 11 is completed when the phase of the difference (IPD1-IPD2) is shifted by 360 degrees from the initial phase, and the temperature of the optical waveguide B at which the difference (IPD1-IPD2) has a local maximum value is detected (selected) from the result of the scanning.

After the completion of scanning, the controller 11 controls the driving voltage that the voltage supplier 8 supplies to the temperature adjustor 14 such that the temperature of the optical waveguide B becomes the selected temperature. In accordance with the control, the temperature of the optical waveguide B converges on the selected temperature after the completion of scanning and the difference (IPD1-IPD2) converges on the local maximum value (see “waveform under control” in FIG. 14).

As the above, also when the range (sweep range) in which the temperature of the optical waveguide B varies is set to be a range in which the phase of the delay interferometer 6 shifts by at least 360 degrees from the initial phase, the same advantages as the third and the fourth modifications can be ensured by detecting a target value of control of the temperature of the optical waveguide B at which the difference (IPD1-IPD2) has a local maximum value.

### (g) Sixth Modification

As performed in this example, the controller 11 may sweep the temperature of the optical waveguide B in a range in which the IPD1 shifts to a local maximum value from the initial value (the first sampled value). Thereby, the controller 11 completes the sweep of the temperature of the optical waveguide B at a time point when the IPD1 has a local maximum value.

In this case, the sweep detects a single point at which the IPD1 has a local maximum value and the controller 11 can control the temperature of the optical waveguide B, regarding the detected point as the target value of control.

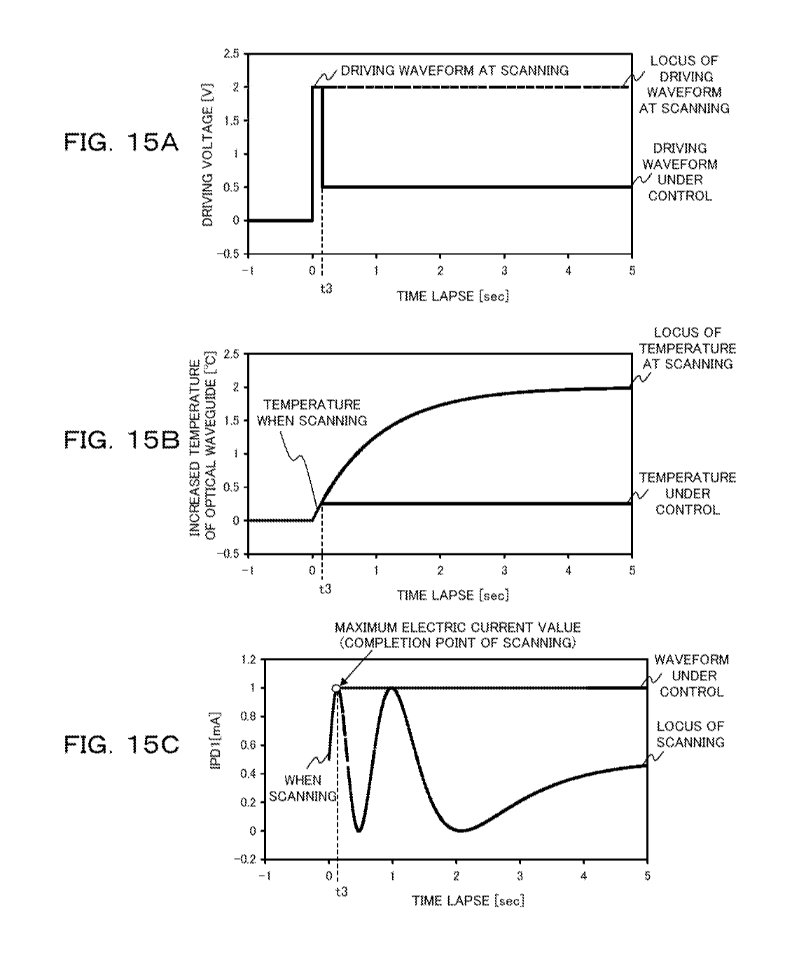

FIG. 15A denotes an example of a driving voltage that the voltage supplier 8 supplies.

As denoted in FIG. 15B, the temperature of the optical waveguide B transitively varies when the voltage supplier 8 applies a step voltage (see “driving voltage at scanning” and “locus driving voltage at scanning”) having amplitude of 2 V to the temperature adjustor 14 in the manner denoted in FIG. 15A. In accordance with the temperature variation of the optical waveguide B, the IPD1 varies as depicted in the example of FIG. 15C (see “when scanning” and “locus of scanning”).

In the illustrated example, the scan by the controller 11 is completed at a time point t3 (where, t3 is a natural number) when the IPD1 has a local maximum value.

Then the controller 11 controls the driving voltage that the voltage supplier 8 supplies to the temperature adjustor 14 such that the temperature of the optical waveguide B becomes one at the time point t3 (see “driving waveform under control” in FIG. 15A). In accordance with the control, the temperature of the optical waveguide B maintains one at the time point t3 (see “temperature under control” in FIG. 15B) and the IPD1 maintains the local maximum value (see “under control” in FIG. 15C).

As the above, also when the range (sweep range by the controller 11) in which the temperature of the optical waveguide B varies is set to be a range until the IPD1 becomes a local maximum value, the controller 11 can detect the target value of control and therefore the same advantages as the foregoing embodiment and the modifications are ensured.

Further, since this modification has a smaller width (sweep range) of the variation in temperature of the optical waveguide B than those of the first embodiment and the above modifications, it is possible to reduce time required for detection of the target value of control, further improving the speed of activation of the delay interferometer 6.

### (h) Seventh Modification

As performed in this example, the controller 11 may sweep the temperature of the optical waveguide B in a range in which the phase of the IPD2 shifts to a local minimum value from the initial value (the first sampled value). Thereby, the controller 11 completes the sweep of the temperature of the optical waveguide B at a time point (completion point of scanning) when the IPD1 has a local minimum value.

In this case, the sweep detects a single point at which the IPD2 has a local minimum value and the controller 11 can control the temperature of the optical waveguide B, regarding the detected point as the target value of control.

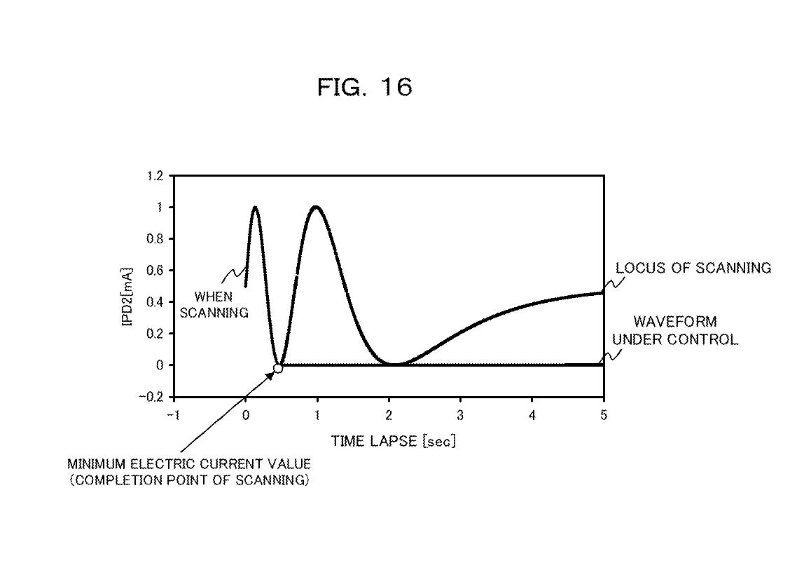

For example, temperature of the optical waveguide B transitively varies when the voltage supplier 8 applies a step voltage having amplitude of 2 V to the temperature adjustor 14. In accordance with the temperature variation of the optical waveguide B, the IPD2 varies as depicted in the example of FIG. 16 (see “when scanning” and “locus of scanning”).

In the illustrated example, the scan by the controller 11 is completed at the time point when the IPD2 becomes a local minimum value.

Then the controller 11 controls the driving voltage that the voltage supplier 8 supplies to the temperature adjustor 14 such that the temperature of the optical waveguide B becomes one at the time point of the completion of scanning. In accordance with the control, the temperature of the optical waveguide B maintains one at the time point of the completion of scanning and the IPD2 maintains the local minimum value (see “when scanning” in FIG. 16).

As the above, also when the range (sweep range) in which the temperature of the optical waveguide B varies is set to be a range until the IPD2 becomes a local minimum value, the controller 11 can detect the target value of control and therefore the same advantages as the sixth modification are ensured.

### (i) Eighth Modification

As performed in this example, the controller 11 may sweep the temperature of the optical waveguide B in a range in which the phase of the difference (IPD1-IPD2) shifts to a local maximum value from the initial value (the first sampled value). Thereby, the controller 11 completes the sweep of the temperature of the optical waveguide B at a time point (completion point of scanning) when the difference (IPD1-IPD2) has a local maximum value.

In this case, the sweep detects a single point at which the difference (IPD1-IPD2) has a local maximum value and the controller 11 can control the temperature of the optical waveguide B, regarding the detected point as the target value of control.

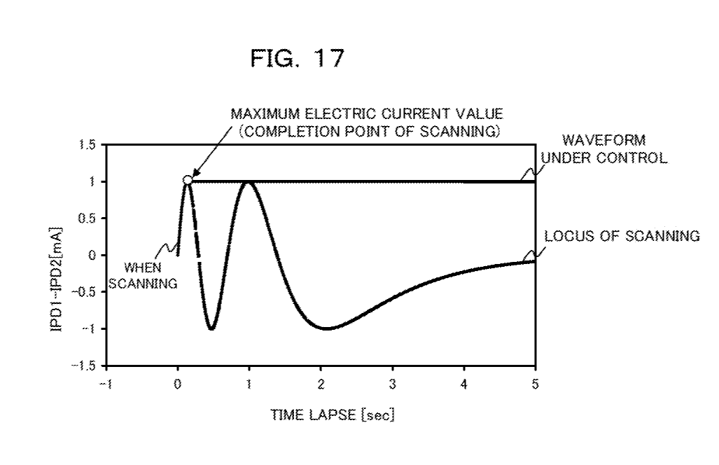

For example, temperature of the optical waveguide B transitively varies when the voltage supplier 8 applies a step voltage having amplitude of 2 V to the temperature adjustor 14. In accordance with the temperature variation of the optical waveguide B, the difference (IPD1-IPD2) varies as depicted in the example of FIG. 17 (see “when scanning” and “locus of scanning”).

In the illustrated example, the scan by the controller 11 is completed at the time point when the difference (IPD1-IPD2) becomes a local maximum value.

Then the controller 11 controls the driving voltage that the voltage supplier 8 supplies to the temperature adjustor 14 such that the temperature of the optical waveguide B becomes one at the time point of the completion of scanning. In accordance with the control, the temperature of the optical waveguide B maintains one at the time point of the completion of scanning and the difference (IPD1-IPD2) maintains the local maximum value (see “waveform under control” in FIG. 17).

As the above, also when the range (sweep range) in which the temperature of the optical waveguide B varies is set to be a range until the difference (IPD1-IPD2) becomes a local maximum value, the controller 11 can detect the target value of control and therefore the same advantages as the sixth and the seventh modifications are ensured.

### (j) Ninth Modification

The foregoing embodiment and the modifications assume that the input signal is a DPSK light signal, but this ninth modification assumes that the input signal is a DQPSK light signal.

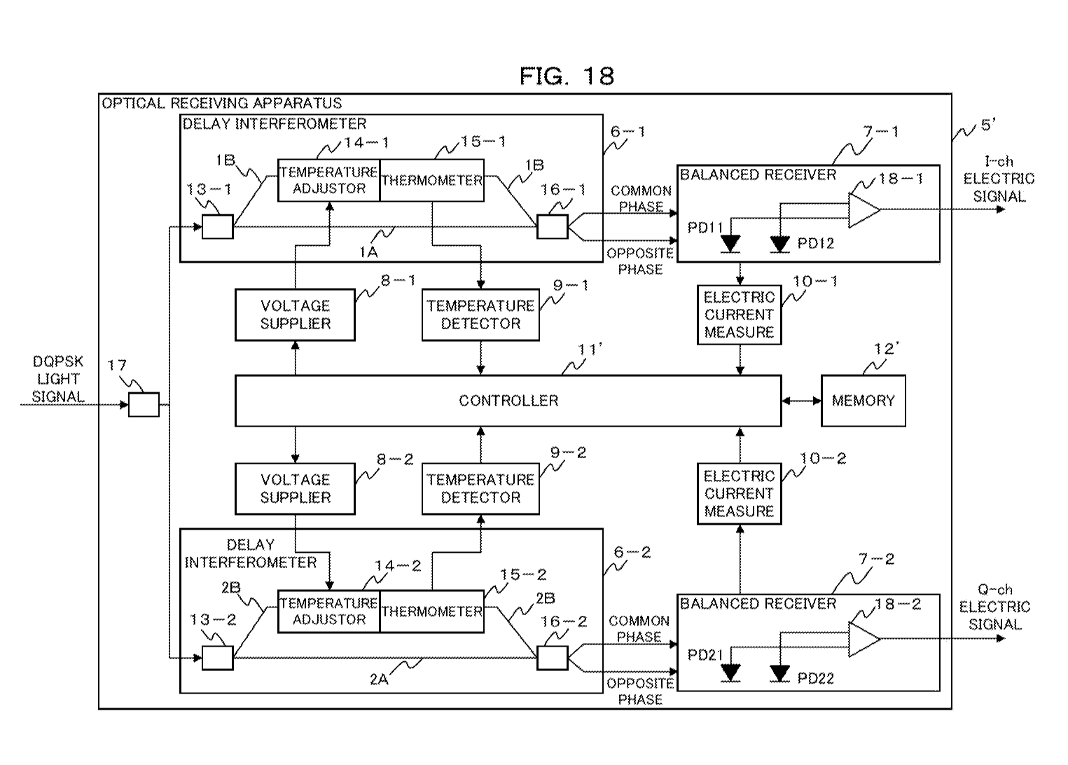

In this modification, the optical receiving apparatus 5 is replaced by, for example, an optical receiving apparatus 5′ exemplified by one depicted in FIG. 18.

The optical receiving apparatus 5′ of FIG. 18 exemplarily includes a dividing circuit 17, delay interferometers 6-1 and 6-2, balanced receivers 7-1 and 7-2, voltage suppliers 8-1 and 8-2, temperature detectors 9-1 and 9-2, electric current measures 10-1 and 10-2, a controller 11′, and a memory 12′.

The dividing circuit 17 divides a DQPSK light signal received in the optical receiving apparatus 5′ into an I-channel (I-ch) component and a Q-channel (Q-ch) component and outputs the I-channel component and the Q-channel component, to the delay interferometer 6-1 and the delay interferometer 6-2, respectively.

The delay interferometer (optical interferometer) 6-1 converts the I-channel component of the DQPSK light signal, which component is obtained by the division in the dividing circuit 17 and which component is in the form of a phase modulated signal, into an intensity modulated signal. For this purpose, the delay interferometer 6-1 exemplarily includes an optical coupler 13-1, two optical waveguides 1A and 1B having different light path lengths, a temperature adjustor 14-1, a thermometer 15-1, and an optical demodulator 16-1.

The optical coupler 13-1, the optical waveguides 1A and 1B having different light path lengths, the temperature adjustor 14-1, the thermometer 15-1, and the optical demodulator 16-1 are identical in function with the optical coupler 13, the optical waveguides A and B having different light path lengths, the temperature adjustor 14, the thermometer 15, and the optical demodulator 16, respectively.

A voltage supplier 8-1 and a temperature detector 9-1 are identical in function with the voltage supplier 8-1 and the temperature detector 9-1, respectively.

The balanced receiver (optical receiver) 7-1 receives the common phase component and the opposite phase component of the intensity modulated signal output from the delay interferometer 6-1, and performs photoelectric conversion on the components into electric signals. Consequently, the balanced receiver 7-1 outputs the difference between the resultant electric signals as an electric signal (demodulated signal) of the I-channel component. For this purpose, the balanced receiver 7-1 exemplarily includes photodiodes PD11 and PD12 and a differential amplifier 18-1.

The photodiodes PD11 and PD12 and the differential amplifier 18-1 are identical in function with the above PD1 and PD2, and the differential amplifier 18, respectively.

Further, an electric current measure 10-1 is identical in function to the electric current measure 10 described above.

The delay interferometer (optical interferometer) 6-2 converts the Q-channel component of the DQPSK light signal which component is obtained by the division in the dividing circuit 17 and which component is in the form of a phase modulated signal into an intensity modulated signal. For this purpose, the delay interferometer 6-2 exemplarily includes an optical coupler 13-2, two optical waveguides 2A and 2B having different light path lengths, a temperature adjustor 14-2, a thermometer 15-2, and an optical demodulator 16-2.

The optical coupler 13-2, the optical waveguides 2A and 2B having different light path lengths, the temperature adjustor 14-2, the thermometer 15-2, and the optical demodulator 16-2 are identical in the optical couplers 13 and 13-1, the optical waveguides A and B and 1A and 1B having different light path lengths, the temperature adjustors 14 and 14-1, the thermometers 15 and 15-1, and the optical demodulators 16 and 16-1, respectively.

A voltage supplier 8-2 and a temperature detector 9-2 are identical in function with the voltage suppliers 8 and 8-1 and the temperature detectors 9 and 9-1, respectively.

The balanced receiver (optical receiver) 7-2 receives the common phase component and the opposite phase component of the intensity modulated signal output from the delay interferometer 6-2, and performs photoelectric conversion on the components into electric signals. Consequently, the balanced receiver 7-2 outputs the difference between the resultant electric signals as an electric signal (demodulated signal) of the Q-channel component. For this purpose, the balanced receiver 7-2 exemplarily includes photodiodes PD21 and PD22 and a differential amplifier 18-2.

The photodiodes PD21 and PD22 and the differential amplifier 18-2 are identical in function with the above PD1 and PD1A, PD2 and PD2A, and the differential amplifiers 18 and 18-1, respectively.

Further, an electric current measure 10-2 is identical in function to the electric current measures 10 and 10-1 described above.

The voltage suppliers 8-1 and 8-2, the temperature detectors 9-1 and 9-2, and the electric current measures 10-1 and 10-2 may take respective integrated forms that are commonly used, which can reduce the cost and the size of the apparatus.

Here, the controller 11′ of this modification varies the temperatures of the optical waveguides 1B and 2B with of the use of the voltage suppliers 8-1 and 8-2 and the temperature adjustors 14-1 and 14-2, and thereby controls the phases of the delay interferometers 6-1 and 6-2.

First of all, the controller 11′ controls the voltages that the voltage suppliers 8-1 and 8-2 respectively supply to the temperature adjustors 14-1 and 14-2 and sweeps the temperatures of optical waveguides 1B and 2B in predetermined ranges.

Next, the controller 11′ monitors the results of sampling by the temperature detectors 9-1 and 9-2 and the result of sampling by the electric current measures 10-1 and 10-2 while sweeping the temperatures of the optical waveguides 1B and 2B in the predetermined ranges.

On the basis of the results of monitoring by the temperature detectors 9-1 and 9-2 and the electric current measures 10-1 and 10-2, the controller 11′ creates a table in which the temperatures of the optical waveguides 1B and 2B and the average photocurrents IPD11, IPD12, IPD21, and IPD22 of the PD11, the PD12, the PD21, and the PD22 are associated with one another. Hereinafter, the IPD11 and the IPD21 are sometimes simply represented by the IPD1s when there is no requirement to discriminate from each other; and the IPD12 and the IPD22 are sometimes simply represented by the IPD2s when there is no requirement to discriminate from each other.

The table created by the controller 11′ is stored into a memory 12′, which serves as a memory to store the table. The table may be created each time the delay interferometers 6-1 and 6-2 are activated or may be updated at regular or irregular intervals.

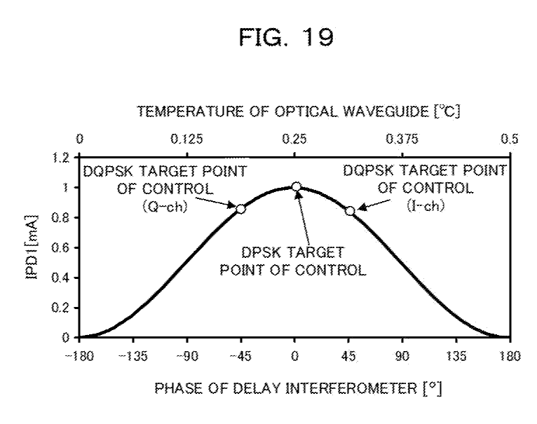

Here, description will now be made in relation to a control target point when the input signal light serves as a DQPSK light signal with reference to FIG. 19.

As depicted in FIG. 19, when the input signal light serves as a DPSK light signal, the target point of control (the DPSK target point of control) is one at which the IPD1 has a local maximum value (otherwise at which the IPD2 has a local minimum point or at which the difference (IPD1-IPD2) has a local maximum point), for example.

Assuming that the phases of the delay interferometers 6-1 and the 6-2 at that time is 0 degree, the target point of control of the I-channel component of the DQPSK light signal is a point shifted by 45 degrees from the above DPSK target point of control while the target point of control of the Q-channel component of the DQPSK light signal is a point shifted by −45 degrees from the above DPSK target point of control.

Therefore, the controller 11′ firstly detects the temperatures of the optical waveguides 1B and 2B at the DPSK target point of control in the above manner, and then detects temperatures of the optical waveguides 1B and 2B at which the IPD1 becomes another value (specifically, a local maximum value or a local minimum value) in this example.

Subsequently, the controller 11′ calculates the difference of the temperatures of the optical waveguides 1B and 2B at which the phases of the delay interferometers 6-1 and 6-2 shift by 45 degrees based on the difference between the two detected temperature and the difference between the detected extreme values.

The controller 11′ adds the temperature difference that has been calculated to the temperature of the optical waveguide 1B at the DPSK target value of control, and thereby obtains the temperature of the optical waveguide 1B at the target point of control of the I-channel component of the DQPSK light signal. In the meantime, the controller 11′ subtracts the calculated temperature difference from the temperature of the optical waveguide 2B at the DPSK target value of control, and thereby obtains the temperature of the optical waveguide 2B at the target point of control of the Q-channel component of the DQPSK light signal.

Next, the controller 11′ controls the voltage suppliers 8-1 and 8-2 and the temperature adjustors 14-1 and 14-2 to heat the optical waveguide 1B and cool the optical waveguide 2B such that the temperatures of the optical waveguides 1B and 2B become the above calculated temperatures.

Specifically, the controller 11′, the voltage suppliers 8-1 and 8-2, and the temperature adjustors 14-1 and 14-2 unitedly function as an example of a controller that sweeps the temperatures of the optical waveguides 1B and 2B in predetermined ranges and concurrently monitors the result of the detection in the temperature detectors 9-1 and 9-2 and the result of the detection in the electric current measures 10-1 and 10-2; detects (selects) the temperatures of the optical waveguides 1B and 2B at which the IPD1s in the balanced receivers 7-1 and 7-2 become extreme values and the temperatures of the optical waveguides 1B and 2B at which the IPD1s in the balanced receivers 7-1 and 7-2 become other values based on the result of the above scanning; calculates a difference of the temperature which shifts the phases of the delay interferometers 6-1 and 6-2 by 45 degrees based on the detected two temperatures; and varies the temperatures of the optical waveguides 1B and 2B to the temperatures higher or lower by the calculated temperature difference.

The controller 11′ may control the voltage suppliers 8-1 and 8-2 and the temperature adjustors 14-1 and 14-2 through PID control so that the temperatures of the optical waveguides 1B and 2B are varied. Such PID control make it possible to more rapidly control the temperatures of the optical waveguides 1B and 2B to target values of control.

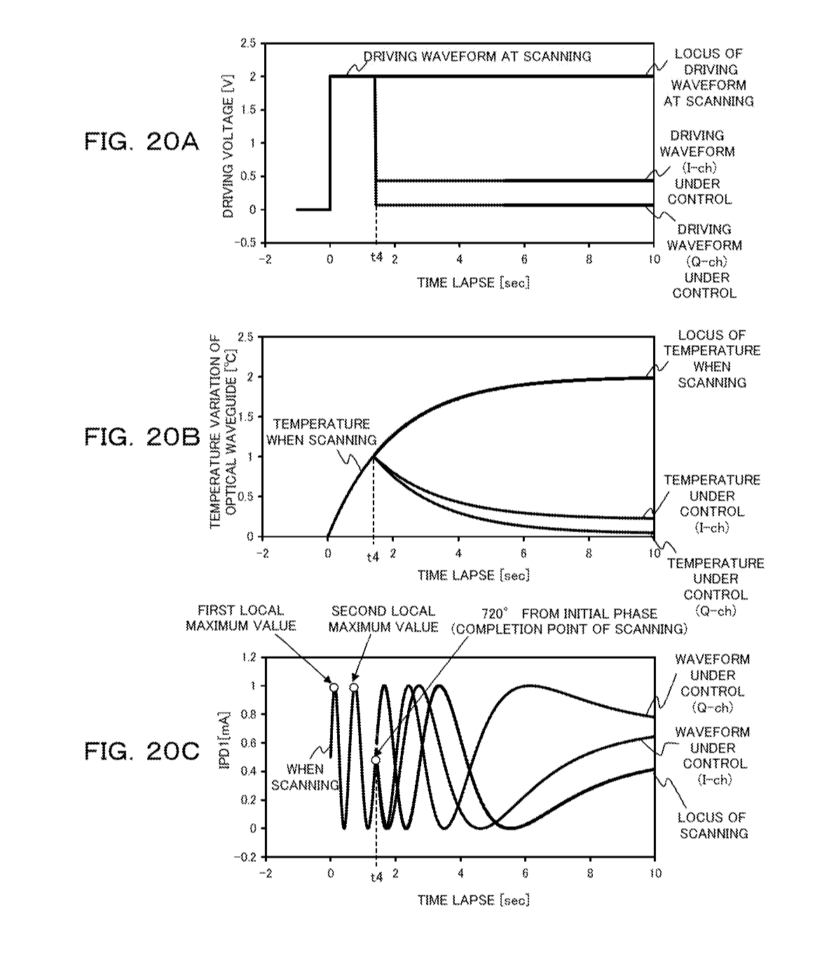

Here, description will now be made in relation to an example of the operation performed by the optical receiving apparatus 5′ with reference to FIGS. 20A through 20C.

As denoted in FIG. 20A, in application of a step voltage having amplitude of 2 V to the temperature adjustors 14-1 and 14-2 from the voltage suppliers 8-1 and 8-2 (see “driving waveform at scanning” and “locus of driving waveform at scanning” in the drawing), the temperatures of the optical waveguides 1B and 2B transitively vary as depicted in FIG. 20B (see “temperature when scanning” and “locus of temperature when scanning”). Further, in accordance with the temperature variation of the optical waveguides 1B and 2B, the IPD1s vary in sine wave as depicted in FIG. 20C (see “when scanning” and “locus of scanning” in the drawing).

In the illustrated example, the scan by the controller 11′ is completed at the time point t4 (where t4 is a natural number) at which the phases of the IPD1s are shifted by 720 degrees from the initial phase, and detects (selects), based on the result of the scanning, the temperatures of the optical waveguides 1B and 2B at which the IPD1s have the another local maximum values.

Further, the controller 11′ detects (selects) the temperatures of the optical waveguides 1B and 2B at which the IPD1s have the other local maximum values based on the result of the monitoring.

Then, for each of the optical waveguides 1B and 2B, the controller 11′ calculates the difference of the temperatures related to the calculated two local maximum values and the difference of the phases of the two local maximum values, and calculates a temperature difference that shifts the phases of the delay interferometers 6-1 and 6-2 by 45 degrees based on the calculated differences. In the example of FIG. 20C, the amounts of variation in temperature of the optical waveguides 1B and 2B which amounts shift the phases of the delay interferometers 6-1 and 6-2 by 45 degrees are calculated by multiplying the differences the temperatures of the optical waveguides 1B and 2B corresponding to the local maximum values of the IPD1s and those corresponding to the other local maximum values by 45 degrees/360 degrees which multiplying is carried out by the controller 11′.

After the time point t4, the controller 11′ controls the driving voltage that the voltage supplier 8-1 supplies to the temperature adjustor 14-1 such that the temperature of the optical waveguide 1B becomes the sum of the temperature of the optical waveguide 1B corresponding to the local maximum value of the IPD11 and the calculated amount of variation (i.e., the temperature difference) (see “driving waveform (I-ch) under control” in FIG. 20A). Meanwhile, after the time point t4, the controller 11′ controls the driving voltage that the voltage supplier 8-2 supplies to the temperature adjustor 14-2 such that the temperature of the optical waveguide 2B becomes the difference obtained by subtracting the calculated amount of variation (i.e., the temperature difference) from the temperature of the optical waveguide 2B corresponding to the local maximum value of the IPD21 (see “driving waveform (Q-ch) under control” in FIG. 20A).

Accordingly, the temperatures of the optical waveguides 1B and 2B converge on the above temperatures after the time point t4 (see “temperature under control (I-ch) and “temperature under control (Q-ch)”) in FIG. 20B), and the IPD11 and IPD21 converge on values shifted by 45 degrees from the local maximum value (see “waveform under control (I-ch)” and “waveform under control (Q-ch) in FIG. 20C).

As the above, the optical receiving apparatus 5′ of the illustrated example ensures the same advantages as the foregoing embodiment and modifications even when an input signal light is a DQPSK light signal.

### (k) Tenth Modification

The above ninth embodiment detects two local maximum values of the IPD1 and calculates a temperature difference that shifts the phases of the delay interferometers 6-1 and 6-2 by 45 degrees. This example aims at realization of the same operation as the above ninth modification by calculating the temperature difference based on other values.

For example, the controller 11′ may alternatively detect two local minimum values of the IPD1 and multiply 45 degrees/360 degrees and the difference between the temperatures of the optical waveguide corresponding to the detected local minimum values so that the temperature difference is calculated which shifts the phases of the delay interferometers 6-1 and 6-2 by 45 degrees.

Further alternatively, the controller 11′ may detect a local maximum value and a local minimum value of the IPD1 and multiply 45 degrees/180 degrees and the difference between the temperatures of the optical waveguide corresponding to the detected local minimum value and local maximum value so that the temperature difference is calculated which shifts the phases of the delay interferometers 6-1 and 6-2 by 45 degrees. In this case, the controller 11′ may sweep the temperature of the optical waveguides in a range in which the phases of the IPD1s shift by at least 360 degrees from the initial phases.

Still further alternatively, the controller 11′ may detect two local minimum values (or two local maximum values) of the IPD2s and multiply 45 degrees/360 degrees and the difference between the temperatures of the optical waveguide corresponding to the detected local minimum values (or the detected local maximum values) so that the temperature difference is calculated which shifts the phases of the delay interferometers 6-1 and 6-2 by 45 degrees.

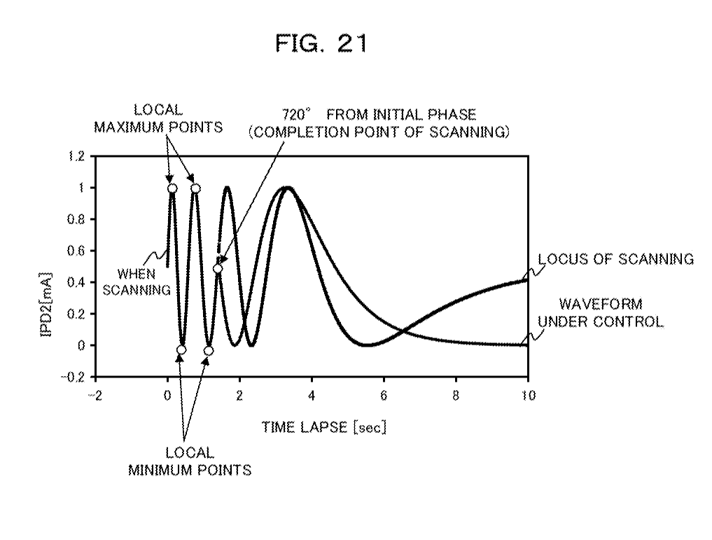

Otherwise, the controller 11′ may alternatively detect a local minimum value and a local maximum value of the IPD2s and multiply 45 degrees/180 degrees and the difference between the temperatures of the optical waveguide corresponding to the detected local minimum value and local maximum value so that the temperature difference is calculated which shifts the phases of the delay interferometers 6-1 and 6-2 by 45 degrees as denoted in the example of FIG. 21. In this case, the controller 11′ may sweep the temperature of the optical waveguide in a range in which the phases of the IPD2s shift by at least 360 degrees from the initial phases.

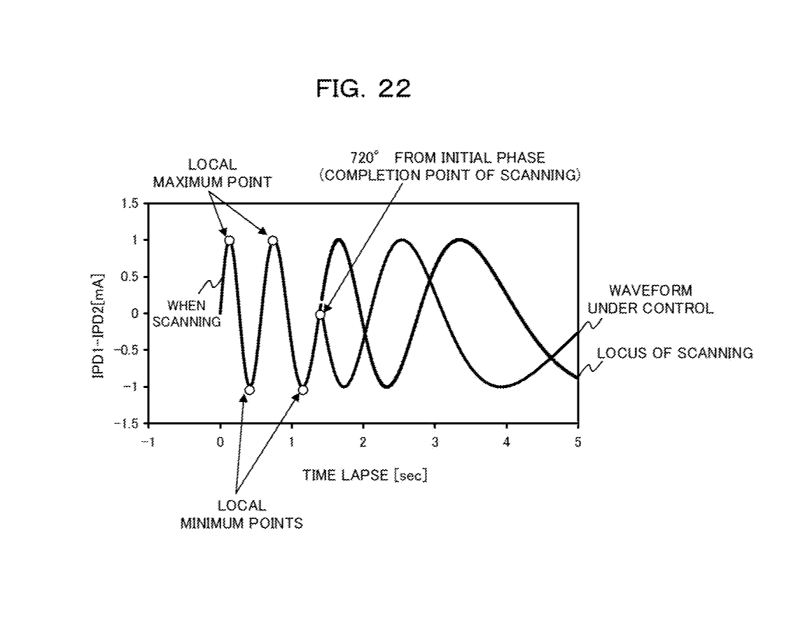

Further, as denoted in the example of FIG. 22, the controller 11′ may alternatively detect two local maximum values (or two local minimum values) of the difference (IPD1-IPD2) and multiply 45 degrees/360 degrees and the difference between the temperatures of the optical waveguide corresponding to the detected local maximum values (or the detected local minimum values) so that the temperature difference is calculated which shifts the phases of the delay interferometers 6-1 and 6-2 by 45 degrees.

Further, as denoted in the example of FIG. 22, the controller 11′ may alternatively detect a local maximum value and local minimum value of the difference (IPD1-IPD2) and multiply 45 degrees/180 degrees and the difference between the temperatures of the optical waveguide corresponding to the detected local maximum value and the detected local minimum value so that the temperature difference is calculated which shifts the phases of the delay interferometers 6-1 and 6-2 by 45 degrees. In this case, the controller 11′ may sweep the temperature of the optical waveguide in a range in which the phase of the difference (IPD1-IPD2) shifts by at least 360 degrees from the initial phase.

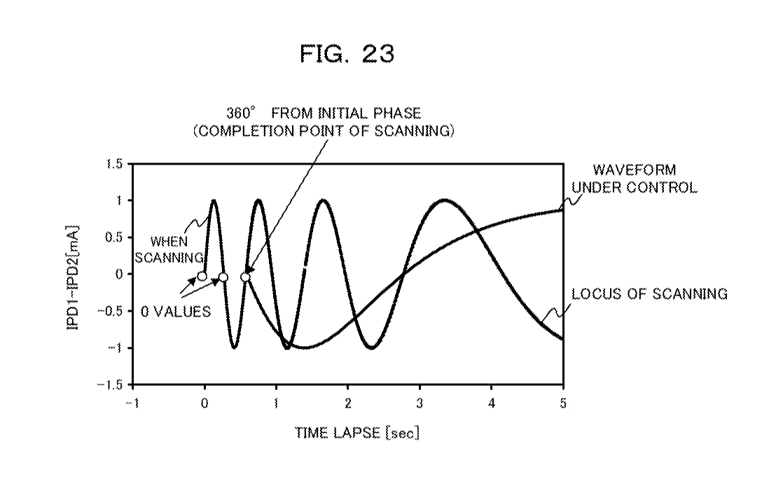

As denoted in the example of FIG. 23, the controller 11′ may alternatively detect a number of temperatures of the optical waveguide at which the difference (IPD1-IPD2) becomes zero and multiply 45 degrees/180 degrees and the differences between the detected temperatures so that the temperature difference is calculated which shifts the phases of the delay interferometers 6-1 and 6-2 by 45 degrees. In this case, the controller 11′ may sweep the temperature of the optical waveguide in a range in which the phase of the difference (IPD1-IPD2) shifts by at least 360 degrees from the initial phase.

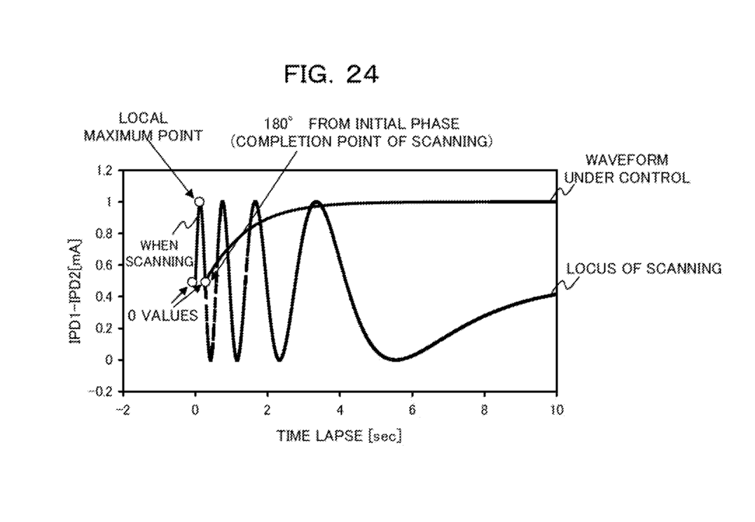

As denoted in the example of FIG. 24, the controller 11′ may alternatively detect temperatures of the optical waveguide at which the difference (IPD1-IPD2) becomes zero and a local maximum value (or a local minimum value) and multiply 45 degrees/90 degrees and the difference between the detected temperatures of the optical waveguide so that the temperature difference is calculated which shifts the phases of the delay interferometers 6-1 and 6-2 by 45 degrees. In this case, the controller 11′ may sweep the temperature of the optical waveguide in a range in which the phase of the difference (IPD1-IPD2) shifts by at least 180 degrees from the initial phase.

As described above, the optical receiving apparatus 5′ of this example can calculate a temperature difference that shifts the phases of the delay interferometers 6-1 and 6-2 by 45 degrees so that the same advantages as the ninth modification can be ensured.

### (k) Eleventh Embodiment

Alternatively, the target value of control of the temperature of the optical waveguide B may be calculated through the use of the average photocurrent drawing a sine wave.

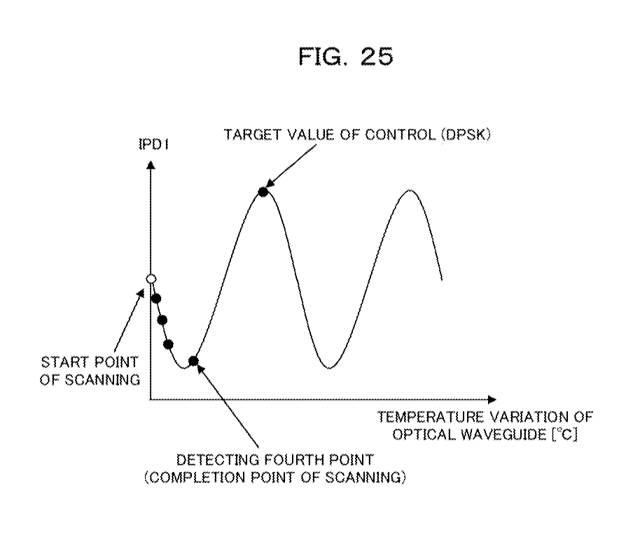

For example, as denoted in FIG. 25, the controller 11 (11′) of the present example completes the control over the sweep of the temperature of the optical waveguide at the time when at least four points are detected from the initial value (the start point of scanning) of the IPD1.

Then, the controller 11 (11′) of the present example calculates unknown numbers a-d using simultaneous equations obtained by substituting the detected values into the following formula (1) and derives the function which expresses the IPD1.

IPD1=a×sin(b×Temp+c)+d (1)

(where, Temp represents the temperature of the optical waveguide B)

Solving the simultaneous equations derived from the above formula (1), the controller 11 (11′) of the present example calculates the temperature of the optical waveguide at which the IPD1 has a local maximum value.

In other words, the controller 11 (11′) of the present embodiment functions as an example of a controller that monitors the result of detection by the temperature detector 9 (9-1 and 9-2) and the result of detection by the electric current measure 10 (10-1 and 10-2) while sweeping of the temperature of the optical waveguide B in a predetermined range; detects at least four combinations each including the IPD1 and the corresponding temperature of the optical waveguide B; calculating a temperature of the optical waveguide B at which the IPD1 has a local maximum value based on the detected combinations; and varies the temperature of the optical waveguide B to the calculated temperature.

Alternatively, the controller 11 (11′) may carry out the above calculation using the IPD2 or the difference (IPD1-IPD2) as the substitute for the IPD1.

Further, the controller 11(11′) can calculate a DPSK target point of control based on the above derived function and may be calculated a DQPSK target point of control based on the same function.

As the above, when the range (i.e., the sweep range) of variation in temperature of the optical waveguide B is set to be a range in which at least four IPD1s are detected, a target value of control can be detected, ensuring the same advantages as the foregoing examples.

In addition, since this embodiment has a narrower range (i.e., the sweep range) of variation in temperature of the optical waveguide B than those of the above embodiment and modifications, the time required for detection of a target value of control can be reduced and thereby the speed of activating the delay interferometers 6-1 and 6-2 can be further improved.

### (l) Twelfth Embodiment

Further, the target voltage V_{T} (V_{T}>0) at which the IPD1 has a local maximum value may be calculated based on the relationship that the temperature of the optical waveguide B is proportional to a driving voltage after a sufficient time period since the driving voltage has been supplied to the temperature adjustor 14 (14-1 and 14-2) as performed in this example.

The controller 11 (11′) of the present example supplies a driving voltage (e.g., a step voltage having amplitude V (V>0)) that shifts the phase of the IPD1 by at least 360 degrees from the initial phase to the temperature adjustor 14 (14-1 and 14-2) and measures a time period (the sampling time T (T>0)) until the IPD1 becomes a local maximum value.

The controller 11 (11′) of the present example calculates the target voltage V_{T} of control that makes the IPD1 be a local maximum value by substituting the detected and measured values into the formula (2) below.

V_{T}=V×{1−exp(−T/τ)} (2)

(where, τ represents the time constant of the temperature adjustor 14 (14-1 and 14-2))

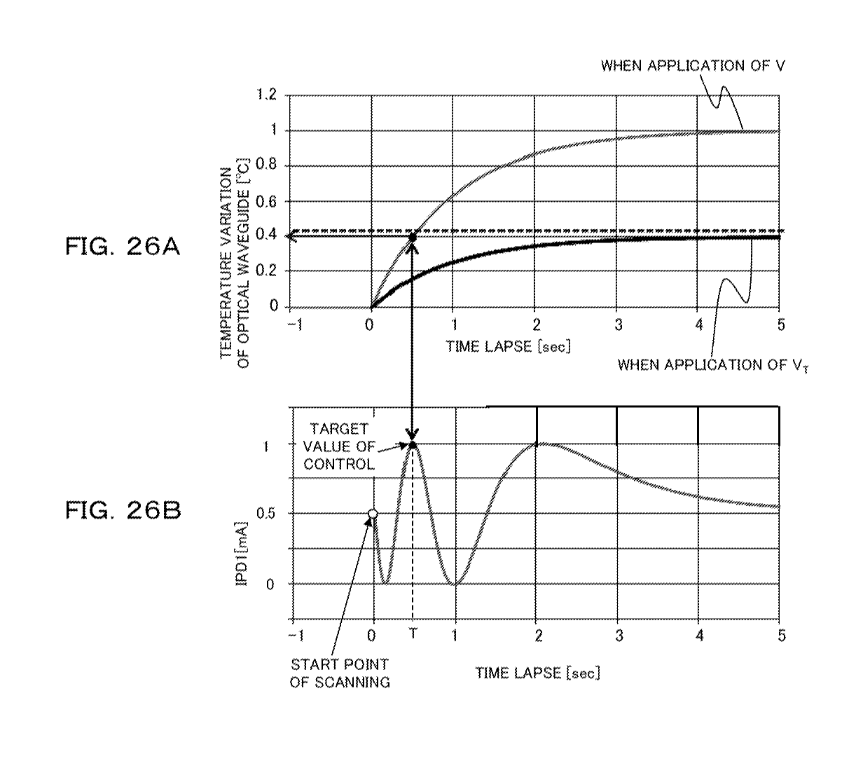

Here, FIG. 26A denotes the variation in temperature of the optical waveguide B when a step voltage V is applied (see “when applying V” in the drawing). The IPD1 takes a local maximum value at the time T as denoted in FIG. 26B and the amount of variation in temperature of the optical waveguide B is 0.4° C. In the FIGS. 26A and 26B, τ=1 sec and the tuning range is a 2FSR (Free Spectrum Range).

Here, the target voltage V_{T} derived from the above formula (2) is a value which is capable of controlling the temperature of the optical waveguide B to one at which the IPD1 has a local maximum value. In other words, in application of the calculated target voltage V_{T} to the temperature adjustor 14 (14-1 and 14-2) since the start of scanning, the temperature of the optical waveguide B converges on the target value (an amount of temperature variation of 0.4° C.) of control (see “when applying V_{T}” in FIG. 26A).

As the above, the controller 11 (11′) of the present example can optimize the phase of the delay interferometer 6 (6-1 and 6-2) by controlling the voltage supplier 8 (8-1 and 8-2) based on the target voltage V_{T} derived from the above formula (2).

Alternatively, the controller 11 (11′) of the present example can perform the above calculation using the IPD2 or the difference (IPD1-IPD2) as the substitute for the IPD1.

Since this example can optimum the phase of the delay interferometer 6 (6-1 and 6-2) without the detection of the temperature of the optical waveguide B, it is possible to omit the temperature detector 9 (9-1 and 9-2) and the thermometer 15 (15-1 and 15-2).

Accordingly, the optical receiving apparatus 5 (5′) of this example can ensure the same advantages as the foregoing embodiment and modifications and can additionally reduce the size thereof.

### (m) Others

The configurations of the optical receiving apparatuses 5 and 5′ and processing performed by the optical receiving apparatuses 5 and 5′ can be omitted and appropriately combined according to the requirements.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments have been described in detail, it should be understood that the various changes, substitutions, and alterations could be made hereto without departing from the spirit and scope of the invention.

What is claimed is:

1. An optical receiving apparatus comprising:
an optical interferometer which comprises a first optical waveguide and a second optical waveguide having light paths different in length and which converts a phase modulated signal received by the optical receiving apparatus into an intensity modulated signal;
a controller which controls a phase of the optical interferometer by varying a temperature of the first optical waveguide;
a temperature detector which detects the temperature of the first optical waveguide;
an optical receiver which receives the intensity modulated signal output from the optical interferometer, converts the intensity modulated signal into an electric signal, and outputs the electric signal; and
an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; selects the temperature of the first optical waveguide at which temperature the average photocurrent has an extreme value based on the result of the monitoring; and varies the temperature of the first optical waveguide to the selected temperature.

2. An optical receiving apparatus comprising:
an optical interferometer which comprises a first optical waveguide and a second optical waveguide having light paths different in length and which converts a phase modulated signal received by the optical receiving apparatus into an intensity modulated signal;
a controller which controls a phase of the optical interferometer by varying a temperature of the first optical waveguide;
a temperature detector which detects the temperature of the first optical waveguide;
an optical receiver which receives the intensity modulated signal output from the optical interferometer, converts the intensity modulated signal into an electric signal, and outputs the electric signal; and
an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; selects two temperatures of the first optical waveguide at which temperatures the average photocurrent has an extreme value and another value based on the result of the monitoring; calculates a temperature difference that shifts a phase of the optical interferometer by 45 degrees based on the selected two temperatures; and varies the temperature of the first optical waveguide to a temperature which is higher or lower than the temperature at which the average photocurrent has the extreme value by the calculated temperature difference.

3. An optical receiving apparatus comprising:
an optical interferometer which comprises a first optical waveguide and a second optical waveguide having light paths different in length and which converts a phase modulated signal received by the optical receiving apparatus into an intensity modulated signal;
a controller which controls a phase of the optical interferometer by varying a temperature of the first optical waveguide;
a temperature detector which detects the temperature of the first optical waveguide;
an optical receiver which receives the intensity modulated signal output from the optical interferometer, converts the intensity modulated signal into an electric signal, and outputs the electric signal; and
an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; detects at least four pairs each including a point of the average photocurrent and a temperature of the first optical waveguide corresponding to the point based on the result of the monitoring; calculates the temperature of the first optical waveguide at which temperature the average photocurrent has an extreme value based on the four detected pairs; and varies the temperature of the first optical waveguide to the calculated temperature.

4. The optical receiving apparatus according to claim 1, wherein the predetermined range is a range in which a phase of the optical interferometer shifts by at least 360 degrees from an initial phase.

5. The optical receiving apparatus according to claim 1, wherein the predetermined range is a range in which a phase of the optical interferometer shifts by at least 720 degrees from an initial phase.

6. The optical receiving apparatus according to claim 1, wherein the predetermined range is a range in which the average photocurrent shifts from an initial value to the extreme value.

7. The optical receiving apparatus according to claim 1, wherein:
the average photocurrent is an average photocurrent of a positive phase of the intensity modulated signal; and
the extreme value is a local maximum value on the average photocurrent of the positive phase of the intensity modulated signal.

8. The optical receiving apparatus according to claim 1, wherein:
the average photocurrent is an average photocurrent of an opposite phase of the intensity modulated signal; and
the extreme value is a local minimum value on the average photocurrent of the opposite phase of the intensity modulated signal.

9. The optical receiving apparatus according to claim 1, wherein:
the average photocurrent corresponds to a difference between an average photocurrent of a positive phase of the intensity modulated signal and an average photocurrent of an opposite phase of the intensity modulated signal; and
the extreme value of the average photocurrent is a local maximum value of the average photocurrent of the difference.

10. The optical receiving apparatus according to claim 1, wherein the temperature of the first optical waveguide detected by the temperature detector is replaced by a temperature obtained by calculation based on a time period obtained through time measurement.

11. The optical receiving apparatus according to claim 2, wherein:
the average photocurrent is an average photocurrent of a positive phase of the intensity modulated signal;
the extreme value is a local maximum value on the average photocurrent of the positive phase of the intensity modulated signal; and
the another value is another local maximum value or a local minimum value on the average photocurrent of the positive phase of the intensity modulated signal.

12. The optical receiving apparatus according to claim 2, wherein:
the average photocurrent is an average photocurrent of an opposite phase of the intensity modulated signal;
the extreme value is a local minimum value on the average photocurrent of the opposite phase of the intensity modulated signal; and
the another value is another local minimum value or a local maximum value on the average photocurrent of the opposite phase of the intensity modulated signal.

13. The optical receiving apparatus according to claim 2, wherein:
the average photocurrent corresponds to a difference between an average photocurrent of a positive phase of the intensity modulated signal and an average photocurrent on an opposite phase of the intensity modulated signal;
the extreme value of the average photocurrent is a local maximum value of the difference; and
the another value of the average photocurrent is another local maximum value, a local minimum value, or the zero value on the positive phase of the difference.

14. The optical receiving apparatus according to claim 1, further comprising a memory which stores the result of the monitoring, wherein the controller varies the temperature of the first optical waveguide based on the result of the monitoring stored in the memory.

15. The optical receiving apparatus according to claim 1, wherein the controller varies the temperature of the first optical waveguide through PID (Proportional Integral Derivative) control.

16. A method for optical reception comprising:
converting a received phase modulated signal into an intensity modulated signal by an optical interferometer comprising a first optical waveguide and a second optical waveguide having light paths different in length;
monitoring a temperature of the first optical waveguide and an average photocurrent of the intensity modulated signal output from the optical interferometer while sweeping the temperature of the first optical waveguide in a predetermined range;
selecting the temperature of the first optical waveguide at which temperature the average photocurrent has an extreme value based on the result of the monitoring; and
varying the temperature of the first optical waveguide to the selected temperature.

17. A method for optical reception comprising:
converting a received phase modulated signal into an intensity modulated signal by an optical interferometer comprising a first optical waveguide and a second optical waveguide having light paths different in length;
monitoring a temperature of the first optical waveguide and an average photocurrent of the intensity modulated signal output from the optical interferometer while sweeping the temperature of the first optical waveguide in a predetermined range;
selecting two temperatures of the first optical waveguide at which temperatures the average photocurrent has a first extreme value and has a second extreme value or the zero value based on the result of the monitoring;
calculating a temperature difference that shifts a phase of the optical interferometer by 45 degrees based on the selected two temperatures; and
varying the temperature of the first optical waveguide to a temperature which is higher or lower than the temperature at which the average photocurrent has the extreme value by the calculated temperature difference.

18. A method for optical reception comprising:
converting a received phase modulated signal into an intensity modulated signal by an optical interferometer comprising a first optical waveguide and a second optical waveguide having light paths different in length;
monitoring a temperature of the first optical waveguide and an average photocurrent of the intensity modulated signal output from the optical interferometer while sweeping the temperature of the first optical waveguide in a predetermined range;
detecting at least four pairs each including a point of the average photocurrent and a temperature of the first optical waveguide corresponding to the point based on the result of the monitoring;
calculating the temperature of the first optical waveguide at which temperature the average photocurrent has an extreme value based on the four detected pairs; and
varying the temperature of the first optical waveguide to be the calculated temperature.

19. An optical transmission system comprising:
an optical transmitting apparatus which transmits a phase shifted signal to an optical receiving apparatus; and
the optical receiving apparatus comprising:
an optical interferometer which comprises a first optical waveguide and a second optical waveguide having light paths different in length and which converts a phase modulated signal received by the optical receiving apparatus into an intensity modulated signal;
a controller which controls a phase of the optical interferometer by varying a temperature of the first optical waveguide;
a temperature detector which detects the temperature of the first optical waveguide;
an optical receiver which receives the intensity modulated signal output from the optical interferometer, converts the intensity modulated signal into an electric signal, and outputs the electric signal; and
an electric current measure which measures an average photocurrent of the intensity modulated signal received by the optical receiver, wherein the controller monitors the results of the detecting by the temperature detector and the measuring by the electric current measure while sweeping the temperature of the first optical waveguide in a predetermined range; selects the temperature of the first optical waveguide at which temperature the average photocurrent has an extreme value based on the result of the monitoring; and varies the temperature of the first optical waveguide to the selected temperature.
